(19) United States
(12) Patent Application Publication
(10) Pub. No.: US 2026/0249639 A1
(43) Pub. Date: Aug. 27, 2026

(54) SECURITY DOCUMENT, SYSTEM FOR PRODUCING A SECURITY DOCUMENT, AND METHOD FOR PRODUCING A SECURITY DOCUMENT

(71) Applicant: OVD Kinegram AG, Zug (CH)

(72) Inventors: Harald WALTER, Zug (CH); René STAUB, Zug (CH); René SCHÄDLER, Zug (CH); Anja CATHOMEN, Zug (CH)

(21) Appl. No.: 18/875,822

(22) PCT Filed: Jun. 13, 2023
(86) PCT No.: PCT/EP2023/065819

§ 371 Date: Dec. 17, 2024

(30) Foreign Application Priority Data
Jun. 27, 2022 (DE) 10 2022 115 901.9

(51) Int. Cl. B42D 25/378; B42D 25/324; B42D 25/351

(52) U.S. Cl. CPC B42D 25/378; B42D 25/324; B42D 25/351

(57) ABSTRACT

A security document, a method for producing a security document and a system for producing a security document. The security document includes an absorption region for the formation of at least one item of personalized information, wherein the security document has been processed and/or can be processed in the absorption region such that the at least one item of personalized information visible through absorption of light incident on a first side. The security document further includes a first security element with an optically variable effect, wherein, in the case of observation of the first side, the first security elementis arranged behind the absorption layer and the first security elementis arranged in a first region, wherein the first region overlaps the absorption region partially or over the whole surface and the first region does not overlap the absorption regionin a background region directly adjacent to the absorption region.

The invention relates to a security document, a system for producing a security document and a method for producing a security document.

In a security document, such as an identity card or a passport, a photo of the document owner as well as further personalized data, for example date of birth, gender, place of residence, nationality, or the like, are usually indicated. Forgers attempt to manipulate this personalized data, thus e.g. to alter or replace it. In order to prevent a forgery, personalized data has hitherto been equipped for example with an optically variable security element overlying it. In particular, a manipulation from the front side, such as for example altering the photo through printing on the surface, is hereby to be made more difficult.

However, the personalized data of the security document are present statically in the form of a printed layer or a blackening through laser radiation. Thus, they have no optically variable effect, with the result that they can be relatively easily manipulated and altered by forgers. Furthermore, the contrast, in particular the brightness contrast, of the personalized data with a static background, e.g. an offset print on or over a diffusely scattering, opaque substrate or layer, is limited.

In addition, manipulation attempts are executed from the middle of the security document, such as for example by splitting the layers of the security document, or manipulation attempts are executed from the rear side, such as for example grinding off the carrier material of a security document as far as the photo plane and then printing a different photo. Previous solutions for making a manipulation from the middle or from the rear side more difficult are based, for example, on an optically variable security element which is arranged on the rear side of the security document or on a window close to the photo. However, the previous solutions have a complicated structure and are complicated to check for authenticity because, for example, it is necessary to examine several sides of the security element and thus to turn the security document completely in relation to the observer. Furthermore, security elements on the rear side are cost-intensive because a complex and sensitive structure is necessary in order to guarantee a certain level of protection against forgery.

The object of the invention is therefore to provide an improved security document, an improved system for producing a security element and an improved method for producing a security element, in particular to provide an improved protection against forgery and simpler checkability of the authenticity of the security document.

The object is achieved by a security document according to claim 1. The security document comprises a first side and a second side lying opposite the first side. The security document further comprises at least one absorption layer with an absorption region for the formation of at least one item of personalized information. The security document has been processed and/or can be processed in the absorption region such that the at least one item of personalized information is visible, in particular is visible to the human eye, through absorption of light incident on the first side. The security document additionally comprises a first security element with an optically variable effect. In the case of observation of the first side of the security document, the first security element is arranged behind the absorption layer. Furthermore, the first security element is arranged in a first region, wherein the first region overlaps the absorption region partially or over the whole surface. In the process, the first region does not overlap the absorption region in a background region directly adjacent to the absorption region, such that the at least one item of personalized information has a viewing-angle-dependent contrast, in particular brightness contrast, in a second region, which is formed at least by a partial region of the absorption region and a partial region of the background region directly adjoining it.

The object is further achieved by a system according to claim 32 for producing a security document according to the invention. The system for producing the security document comprises an auxiliary carrier, wherein a first partial element of the security document and a second partial element of the security document are arranged on the auxiliary carrier, wherein the first partial element can be made to overlay the second partial element by bending the auxiliary carrier. The first partial element has the first security element and the second partial element has an adhesive layer and at least one covering and/or a second security element, which is preferably transparent and/or partially metallized and preferably provided over the whole surface in the second partial element, wherein the adhesive layer is arranged on the side of the covering and/or of the second security element facing away from the auxiliary carrier, wherein the absorption layer with the absorption region is arranged on or can be attached to the side of the first partial element facing away from the auxiliary carrier. Preferably, the first partial element has an optional first carrier element and the second partial element has an optional second carrier element.

The object is further achieved by a method according to claim 39 for producing a security document, in particular a security document according to the invention, preferably using a system according to the invention. The produced security document has a first side and a second side lying opposite the first side. In the method, the following steps are carried out, in particular in the specified order:
providing at least one absorption layer with an absorption region for the formation of at least one item of personalized information, wherein the security document has been or is processed and/or can be processed in the absorption region such that the at least one item of personalized information is visible, in particular visible to the human eye, through absorption of light incident on the first side;
   providing a first security element with an optically variable effect;
arranging the absorption layer and the first security element such that, in the case of observation of the first side of the security document, the first security element is arranged behind the absorption layer and the first security element is arranged in a first region. The first region overlaps the absorption region partially or over the whole surface and the first region does not overlap the absorption region in a background region directly adjacent to the absorption region, such that the at least one item of personalized information has a viewing-angle-dependent contrast, in particular brightness contrast, in a second region, which is formed at least by a partial region of the absorption region and a partial region of the background region directly adjoining it.

Through the invention it is achieved that items of personalized information can be backed, over part of the surface or over the whole surface, by an optically variable security element which has a flexible and cost-effective design, as a result of which at the same time costs are reduced, the protection against forgery is increased and checking for authenticity is made easier. Advantageously, alterations and/or forgeries of the personal data can be registered more easily with the human eye and a manipulation can easily stand out even when observed from only one side, namely the first side of the security document. Manipulation attempts thus become recognizable even to the lay person without them needing to use specific equipment. This is achieved because the item of personal information, which has absorbent properties for example because it is provided by laser blackening or printing, locally overlays the optically variable effect of the first security element and for the most part extinguishes it. It can hereby already be perceptible to the human eye that a security document that has not been forged is in perfect register, thus has an exactly defined positional relationship, with the border of absorption regions and background regions. Because the background region is directly adjacent to the absorption region and the first region extends into the absorption region, it can thus be achieved that a perfect register between the background, lighting up more strongly, and the absorption region, lighting up more weakly or not at all, can be recognized by the human observer when the security document is tilted. In particular, the authenticity can thus be verified particularly easily by checking register tolerances since, for example, a manipulation of the absorption layer by attempting to apply the lighting-up background region in front of the absorption region and correspondingly to omit the absorption region always involves a reduced positional accuracy or register tolerance. The optically variable effect of the first security element lying behind the personalization thus cannot be imitated in particular because a corresponding optically variable effect is arranged on the front side of the security document. Since it is not possible for a forger to match the subsequently applied optically variable effect perfectly to the contour of the personalized data, it becomes easier to see that a forgery is present.

The inspection of the security document is in particular also made easier because the recognizability of the items of personal information, such as for example a photo, personalized data or a document identification marking, can be improved through an increased brightness contrast, which is present at a specific observation angle. The increased brightness contrast of the item of personalized information can in particular be made possible through the optically variable effect of the first security element, because it can be perceived as “backlighting” of the item of personalized information. The item of personalized information or the background thereof, in particular the background of a photo of a document owner, can further appear optically variable when the security document is tilted and/or turned, with the result that the item of personalized information is no longer to be seen only statically. In addition, the verification of the security document can also be adequately performed from one side, for example the front side. An examination of the rear side of the security document could also possibly be dispensed with, for example, since the first security element can already be recognized from the front side, wherein the first security element is arranged behind the absorption layer for the formation of the item of personalized information anyway and thus protects against grinding off from the rear side. The verification of the security document is thus speeded up, which is helpful for example in the case of long waiting times at border control.

Disruptive influences at a specific observation angle, such as for example specular reflections or diffractive effects of a diffractive optically variable security element lying on top of the item of personalized information and overlapping it, can additionally be outshone, with the result that a good recognizability of the items of personalized information is guaranteed and the verification of the security document is made easier.

A particularly high degree of protection against forgery of the security document can furthermore also be achieved in that the personalized data can be overlapped by security elements, at least over part of the surface, from the front side and from the rear side, because a further security element can be applied to the front side. An attempt at manipulation from any side thus entails the risk for the forger that the security elements are damaged, and the security document thus becomes unusable.

Further advantageous designs of the invention are described in the dependent claims.

A use of the system according to the invention for producing the security document according to the invention, in particular in the method according to the invention, is conceivable.

The security document is preferably a passport, an identity card, an identification card, a driver's license, a label or a tax sticker, or usable for this. The at least one item of personalized information is preferably selected individually or in combination from image, portrait, motif.

A motif is in particular selected individually or in combination from: a graphically designed outline, a figural representation, an image, a symbol, a logo, a portrait, an alphanumeric character, a text, a rasterization.

By “motif-shaped” is meant in particular in the form of a motif.

By “visible to the human eye” is meant in particular visible in a wavelength range of from 380 nm to 780 nm and in particular from 430 nm to 690 nm. The wavelengths visible to people in particular lie in the range between 380 nm, thus in particular violet, and 780 nm, thus in particular dark red, of the electromagnetic spectrum, wherein the relative sensitivity of the eye below 430 nm and above 690 nm is less than 1% of the maximum value at 555 nm. By “transparent” is preferably meant a transmittance of above 70% and in particular above 90%, in particular for wavelengths in a range of from 430 nm to 690 nm, preferably for wavelengths in the wavelength range visible to the human eye. By “semi-transparent” is preferably meant a transmittance in a range of from 30% to 70%, in particular for wavelengths in a range of from 430 nm to 690 nm, preferably for wavelengths in the wavelength range visible to the human eye. By “opaque” is preferably meant a transmittance of less than 30% and in particular less than 10%, in particular for wavelengths in a range of from 430 nm to 690 nm, preferably for wavelengths in the wavelength range visible to the human eye. By transmittance is preferably meant the ratio of the quantity of a light irradiating and/or incident on a medium to the quantity of light which emerges on the opposite side of the medium, wherein preferably no significant change in the spectral course of the light has taken place. The light not transmitted is preferably reflected, scattered and/or absorbed by the medium. Thus, in the case of a transmittance of a medium of 0.9 or of 90% for example, 90% of the irradiating light is perceptible on the opposite side of the medium. When the transmittance of a layer is considered, in particular reflections at the boundary surfaces of this layer are disregarded.

In the absorption region, in particular, the security document according to the invention has been or is processed, preferably processed in the method according to the invention, such that the at least one item of personalized information is visible, in particular visible to the human eye, through absorption of light incident on the first side. On the first side, here, light incident outside the absorption region is expediently reflected and/or scattered more strongly than in the absorption region.

During the arranging of the absorption layer and the first security element, in particular the absorption layer and the first security element have been or are joined to each other and the at least one item of personalized information has been or is preferably introduced or applied, in particular thereafter, by generating the absorption region.

The absorption region is preferably delimited by one or more contours, wherein a contour forms through joining of adjacent absorbent regions to the background region, wherein the joined absorbent regions are jointly allocated to an item of personalized information, such as for example a portrait, in particular a halftone portrait, or an alphanumeric character. In the case of several pixels generated by means of lasers or a printing technique, e.g. in a halftone image, for example the outermost pixels, allocated to an item of information and adjacent to the background region, form a contour of the absorption region.

By “background region” is preferably meant a region or partial region of the second region directly adjacent to the absorption region, which does not contain an item of personalized information but preferably provides a contrasting background, with the result that the item of personalized information is visible.

By “region” is meant here in particular in each case a defined surface area of a layer, film or ply which is occupied when observed perpendicular to a plane spanned by a corresponding layer, film or ply. Regions, overlaps, widths and lengths are in particular considered in the case of observation perpendicular to a plane spanned by a corresponding layer, preferably wherein the spanned plane is present disregarding the layer thickness of the corresponding layer. Regions extend, in particular with the thus-defined surface area as a base surface, through the security document or the system. A layer is preferably a substantially two-dimensional structure. In particular, a layer can itself be single-layered or multi-layered.

An optically variable effect can in particular be selected individually or in combination from: viewing-angle-dependent contrast, in particular brightness change, viewing-angle-dependent color change, viewing-angle-dependent movement effect, viewing-angle-dependent motif change, holographic representation, kinematographic representation. The viewing angle of a security element, in particular of the first security element, can be varied by an observer in particular by tilting, turning and/or bending the security element. A security element preferably has been or is formed as a laminating film or of a transfer ply of a transfer film.

By “in register” and “register accurate” is meant a positional accuracy of two or more plies, elements, regions and/or layers relative to each other. The register accuracy is to range within a predefined register tolerance, which is to be as small as possible. At the same time, the register accuracy of several plies, elements, regions and/or layers relative to each other is an important feature in order to increase the process reliability and/or the product quality, but also the protection against forgery. The register-accurate or positionally accurate positioning can be effected in particular by means of sensorily, preferably optically, detectable register marks. These register marks can either represent specific separate plies, elements, regions and/or layers or themselves be part of the plies, elements, regions and/or layers to be positioned. By a “perfect register” is meant in particular that there is no register tolerance.

The viewing-angle-dependent contrast is in particular a viewing-angle-dependent brightness contrast, which preferably has been or is provided by a defined brightness difference and/or preferably by a defined difference in brightness differences when observed at different defined observation angles.

Observation of the first side of the security element can in particular take place at predefined observation angles, at which for example the brightness contrast adopts defined values. These predefined observation angles can in particular also be determined by angle ranges and in particular do not necessarily correspond to individual values. The defined observation angles are in particular angle ranges which prevail between incident light, of a plane spanned by a layer or ply of the first security element, or the normal of the spanned plane, and observer or receiver. In particular, the first security element can be moved into an ON state, in which the optically variable effect is visible to the human eye at a defined observation angle, and can be moved into an OFF state, in which the optically variable effect is not visible to the human eye at a different defined observation angle. The optically variable effect of the first security element is preferably visible at the predefined first observation angle and in particular not visible at the second predefined observation angle, in particular wherein the first security element is preferably transparent at the second observation angle.

At a predefined first observation angle, wherein preferably no specular reflection is visible, in particular a maximum amount of light reflected or diffracted by the first security element is visible. Here it is advantageously possible for the structure of the first security element, because in particular 20% of the incident light as a whole is reflected or diffracted, to appear very bright to the observer since the majority of reflected or diffracted light is concentrated in a narrow angle range and in particular is directed to the observer. The remaining in particular 80% of the incident light is scattered, for example only diffusely, by the first side of the security element, in particular a substrate, and appears dark in comparison therewith. The substrate can for example be formed at least by a preferably opaque layer core or a paper substrate. Advantageously, the at least one item of personalized information is particularly easily recognizable when observed at the predefined first observation angle since the absorption region, in particular the blackening, lies at least partially in front of the first security element and, for example, weakens the reflected portion compared with the background region lighting up brightly corresponding to the absorption region, in particular the blackening. The observation of the security document at the first predefined angle preferably corresponds to an ON state of the first security element, in particular wherein the first security element lights up at least in partial regions and preferably lights up homogeneously at least in regions or homogeneously over the whole surface.

At a third predefined observation angle, a specular reflection is preferably visible. In particular, a light source reflecting on the first side of the security document is visible here. This situation can arise in particular in the case of security documents made of plastic with a smooth surface. Here, the typical reflection of approx. 5% of the incident light can outshine the item of personalized information. The absorption region, which comprises blackenings for example, can hardly be recognized since, for example, a preferably bright substrate scatters diffusely and does not appear bright enough to the observer.

By a second predefined observation angle is meant in particular an observation angle outside the first predefined observation angle, at which a specular reflection of a light source is not directly visible, thus preferably also outside the predefined third observation angle. The observation of the security document at the second predefined angle preferably corresponds to an OFF state of the first security element.

A difference in brightness between background region and absorption region in the second region is preferably stronger at a predefined first observation angle than at a predefined second observation angle. Stronger means in particular that the delta ON value described below is greater than delta OFF.

In particular, light incident on the first side of the security document is reflected less strongly in the absorption region than in surrounding regions, as a result of which the item of personalized information is visible, is preferably visible with the human eye, in particular in the ON state and in the OFF state.

It is also conceivable that a difference in brightness between background region and absorption region in a further region is weaker at the predefined first observation angle than at a predefined second observation angle, in particular because, when the first side is observed, a further absorption layer is arranged underneath the first security element and/or the at least one item of personalized information has been or is formed in the further region, preferably when the first side is observed at the second observation angle, additionally through absorption of light incident on the first side, wherein the absorption in particular also takes place underneath the first security element. Weaker means in particular that the delta ON value described below is smaller than delta OFF.

The two embodiments can preferably be combined. An embodiment is conceivable wherein a first difference in brightness between background region and absorption region in the second region is stronger at the predefined first observation angle than at a predefined second observation angle and a second difference in brightness between background region and absorption region in a further region is weaker at the predefined first observation angle than at a predefined second observation angle.

The personalization of documents is typically effected through a preferably dark to black overprint or through the action of laser radiation, in particular through blackening by means of laser radiation. In particular in the case of a printed personalization, colored overprints are also possible, wherein dark colors are preferably used, such as for example dark blue or dark green or dark red. In order that the item of personalized information is easily recognizable, a preferably bright substrate is advantageously used. This can be regions of the substrate not printed on, an areal white print, or such like with a preferably light printing. This can be colors with low saturation, i.e. low absorption, and/or with low surface coverage. In the case of security documents made of plastic, such as for example a card or a data page comprising polycarbonate (PC) or PET, the surface coverage of the printing inks on a layer is preferably less than 50% in order not to weaken the bond in the end product too greatly. In the case of security documents made of plastic there is usually a ply, for example a core layer, which contains fillers, such as for example TiO₂, in order to make the document body largely non-transparent and to achieve a good contrast for the item of personalized information. In particular, because of the fillers, this ply scatters the incident light diffusely over a large angle range and appears white or in white tones.

The ply, in particular the core layer, can contain fillers or colorings, as a result of which it is possible for a colored ply, in particular core layer, to be present as substrate, in particular to be present behind the at least one item of personalized information and behind the first security element when the first side is observed.

White tones are preferably used here. It is thus also possible for a white ply, in particular a white core layer, preferably to be present as substrate, in particular to be present behind the at least one item of personalized information and behind the first security element when the first side is observed.

If the absorption layer is blackened through the action of laser radiation, the blackening is advantageously easily recognizable in contrast to the substrate, which in particular provides a white background. The item of personalized information preferably usually comprises an item of image information and further data. The at least one item of personalized information advantageously has been or is introduced as an item of image information such that different gray tones can be present and/or perceived. Further items of personalized information are preferably present in the form of data in a uniform blackening since no graduation of the blackening is necessary.

As a measure of a blackening, the optical density can be determined with reference to the K value. The optical density is preferably measured according to ISO 13655:2017 (E) “Graphic technology-Spectral measurement and colorimetric computation for graphic arts images”. The measuring device illuminates the sample to be measured in particular via a light ring, which illuminates the sample at 45°. An LED preferably serves as light source. The measurement is effected by means of spectrometers with observation perpendicular to the surface of the sample. The light scattered back by the measured object is measured at an interval of 10 nm in the spectral range of 400 nm to 700 nm.

In order to determine the K value for the optical density, a first measurement is preferably effected without blackening in the security document as reference and a second measurement is effected with blackening at the same point, which serves as reference. It is preferably possible to carry out the measurement in such a way that first of all a reference measurement of the optical density is effected, wherein this reference measurement of the optical density is effected in particular either on an unpersonalized, preferably unblackened, blank document at the same point as on a region blackened later or on the same document at a comparable point with a similar unblackened substrate. Thus, in particular a measurement of a region with optical properties which the security document would have at the measured point without blackening is carried out as reference measured value. A subsequent second measurement of the optical density is effected in the blackened region, and the K value can be calculated from the difference. The optical density results from the negative base 10 logarithm of the quotient of measured value of the reflection with blackening and measured value without blackening. A higher optical density or a higher K value is thus associated with a stronger blackening.

In order to adapt the measurement to the region to be measured, different diaphragms can be used. Typical diameters of the measuring diaphragms lie in the range of 1 mm to 7 mm. In the case of a measuring geometry of 45°: 0° using an x-rite exact device (from X-Rite, registered office Siemensstraße 12b, 63263 Neu-Isenburg, Germany), the following K values for the optical density can be measured.

The blackening in the absorption layer for the formation of the at least one item of personalized information, preferably in the form of a portrait, is measurable with reference to the K value. The absorption region preferably has been or is processed such that the K value of the at least one item of personalized information is in a range between 0 and 3. A value of 0 means that no blackening is present, in particular a bright point without blackening. A value of 3 is a dark and advantageously already clearly visible blackening. Through a maximum value of 3 it is advantageously achieved that damage to the product is prevented, such as for example the formation of bubbles, in particular when foreign materials such as a security element are present in the absorption region. In the case of a low contrast of the at least one item of personalized information, in particular the portrait, the K values are in particular between 0 and 1. In the case of a high contrast of the at least one item of personalized information, in particular the portrait, the K values are between 0 and 2.

The K value is a measure of how strongly the blackening absorbs incident light and corresponds to an optical density of the blackening. The K value is preferably measured in the OFF state.

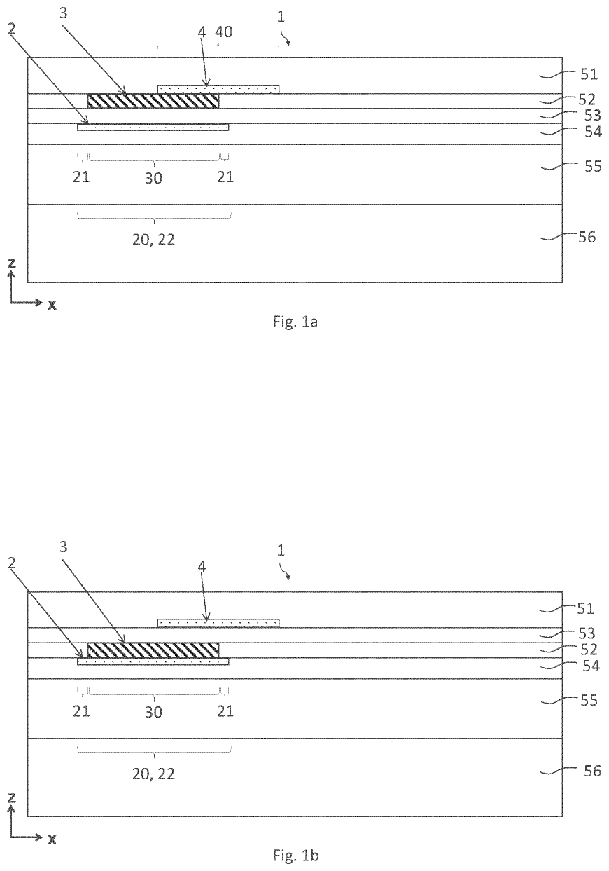

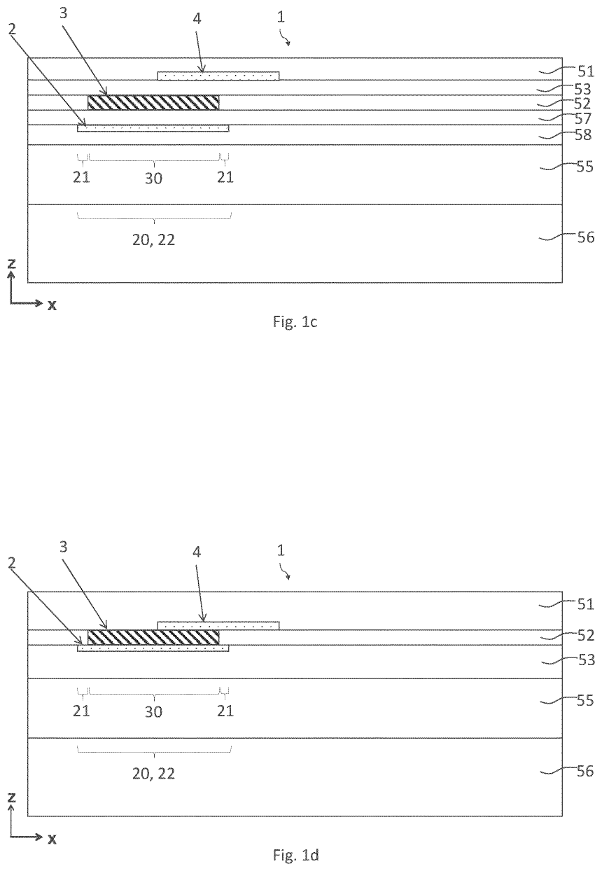

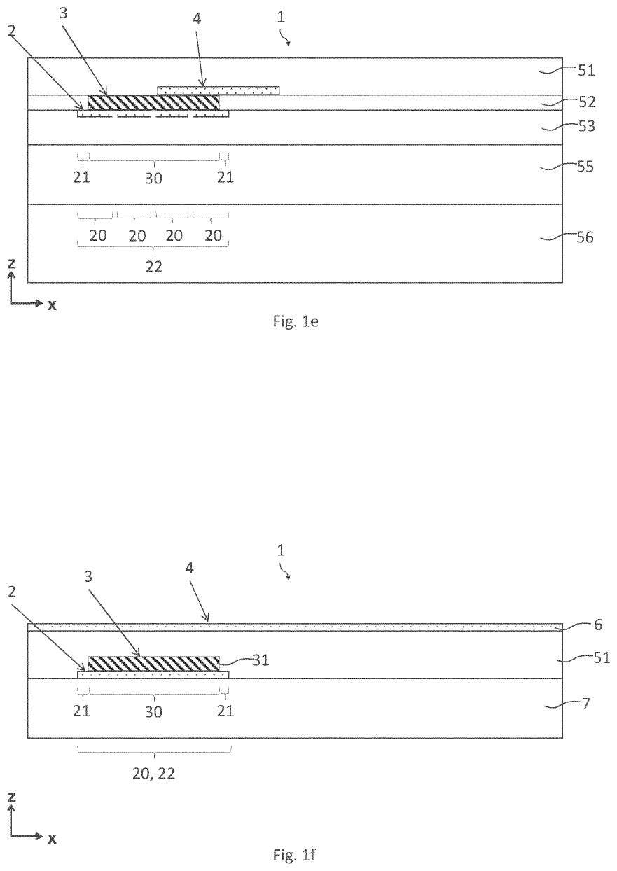

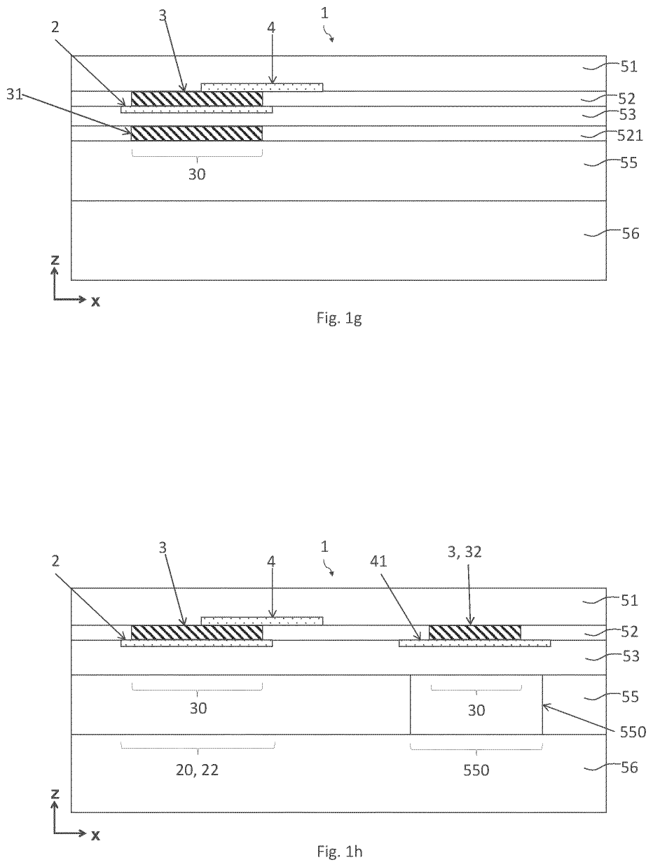

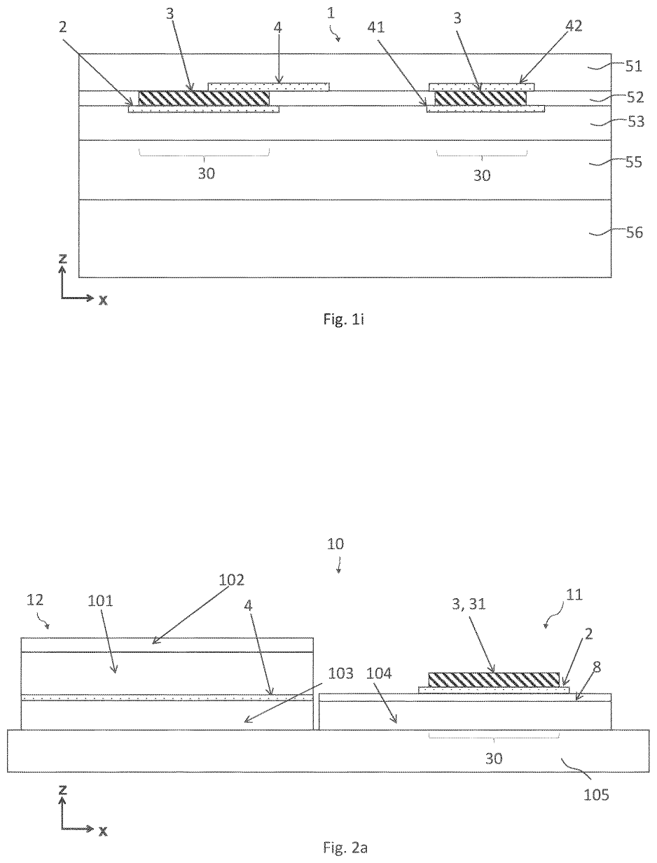

This measurement method detects the whole blackening, in particular in the case of a structure as represented in FIG. 1g for example. That is, both a blackening in the absorption layer and possibly in further layers on top of the first security element and a blackening which is possibly located underneath the preferably transparent first security element.

The brightness contrast, in particular the brightness contrast of the at least one item of personalized information, preferably in the form of a portrait, in the second region is preferably calculated as follows:

In particular, a viewing-angle-dependent brightness contrast preferably has been or is provided by a, preferably predefined, viewing-angle-dependent difference in brightness between the background region and the absorption region.

The difference in brightness between the background and the absorption region, preferably the blackening in the absorption region, can in particular be determined according to the formulas below for delta ON and delta OFF, wherein “ON” denotes when observed at the predefined first observation angle and “OFF” denotes when observed at the predefined second observation angle. The abbreviation MW stands for the measured value ascertained for the brightness. The difference between the measured values ascertained is divided in each case by the measured value at a suitable position in the substrate in order to compensate for any differences in the reflection behavior or scattering behavior or the illumination between the first and second observation angle. In the process, a region of the substrate is used which has comparable properties to the observed background region, or absorption region, and in particular is present neighboring it as far as possible. It is preferably possible to choose as MW substrate a measured value of a region which has corresponding optical properties, which the security document would have at the point of the MW absorption region without processing to make the at least one item of personalized information visible through absorption of light incident on the first side, thus in particular without blackening, and/or at the point of the MW background without the first security element, which, in the corresponding security document, in particular can be a region which is present neighboring the first and/or second region, the background region and/or the absorption region when the first side is observed.

$$delta ON = \frac{M W background ON - M W in the absorption region ON}{M W substrate ON}$$

$$delta OFF = \frac{M W background OFF - M W in the absorption region OFF}{M W substrate OFF}$$

According to an advantageous embodiment of the invention:

$$delta ON > delta OFF$$

A standardized difference D between delta ON and delta OFF advantageously exceeds a minimum value.

$$D = \frac{delta ON - delta OFF}{delta ON} > minimum value$$

Suitable minimum values for the standardized difference D are 5%, preferably 10%, in particular preferably 15%.

In a preferred embodiment, the minimum value applies to a region with the largest standardized difference D.

A higher value of D means a greater increase in the difference in brightness of the measured values between the ON and OFF state and in particular makes the change from the OFF to the ON state more obvious. In addition, this criterion ensures that the blackening in the absorption region is also easily recognizable in the ON state.

It is in particular possible for the difference of brightness differences when observed at different defined observation angles preferably to be defined by the standardized difference D.

Items of personalized information can have fine details and correspondingly vary the blackening greatly locally. A measurement with a conventional densitometer is thus possible only with difficulty. A measurement by means of a camera at with a corresponding resolution makes it possible to still provide information.

Depending on the resolution of the measuring instruments, measured values may possibly vary within a range. If a measurement gives different values for a region, in particular a partial region of the absorption region and/or of the background region, then the median or the arithmetic mean of a corresponding region, in particular of the absorption region and/or of the background region, is preferably used as measured value.

In particular the dimensionless grayscale, or the brightness value, is preferred as measured value for the reflection. To identify the contrast or the optical density or the brightness it is possible to use the following setup.

For this, the security document is expediently arranged such that the first side of the security document is visible or can be captured with a camera and spans a plane with an x axis and a y axis perpendicular thereto, in particular with the coordinate origin in the center of the security document. The perpendicular to this plane, thus in particular in the thickness direction of the security document, can be regarded as the z axis. A camera is preferably arranged above the security document in the z direction. A light source is in particular arranged offset in relation to the security document and the camera such that the light diffracted or scattered back by the first security element at least partly strikes the aperture of the camera. The observation is preferably effected by means of a camera perpendicularly to the first security element, in particular to the xy plane. The illumination is effected laterally such that the light diffracted back or scattered by the first security element at least partly strikes the aperture of the camera. The illumination can be effected by a fluorescent tube, for example. The following table shows an exemplary test setup, wherein the lamp is preferably a fluorescent tube:

| Dimension | Value | |
|---|---|---|
| Height of lamp in the z direction | 175 | mm |
| Length of the lamp in the y direction | 180 | mm |
| Distance of the lamp from the center of | 170 | mm |
| the security document in the x direction | | |
| Height of camera in the z direction | 250 | mm |
| Offset of lamp in the y direction | 90 | mm |
| Diameter of the lamp | 20 | mm |

Through an offset of the lamp of 90 mm, the center of the lamp is in particular located on the x axis running through the center of the security element. The values in the above table show the setting values for image acquisition using the camera. The position of the lamp can be adapted corresponding to the properties of the first security element in each case such that the ON state is captured, thus an observation at the predefined first observation angle. In the case of blazed structures, the important parameter is in particular the angle α of the inclination of the facets of the structure together with the refractive index n, as is described for example in relation to FIG. 3b.

Grayscale values are ascertained in particular from the color value signals (R, G, B) of the camera according to the formula: grayscale value=0.200*red component+0.587*green component+0.114*blue component. The result is a value which expresses the brightness of an image point independently of the colors.

It is possible for the relative difference of the grayscale values between the ON and OFF state to be dependent not only on the substrate, such as e.g. the type and density of a print or a coloring of an opaque core layer, which can be arranged behind the first security element when the first side is observed, but also on the type of light source, in particular on its extent. A point light source will result in a larger relative difference than a broad light source. The described measuring setup represents an intermediate stage.

At the second predefined observation angle, i.e. in particular in the OFF state in which the first security element deflects no light to the observer, thus is not visible, a first brightness value of a measurement region results. This is defined by the average grayscale value. The arithmetic mean or, in particular in the case of very noisy measurement areas, the median is used as average grayscale value. At the predefined first observation angle, in which the first security element deflects light to the observer however, thus is visible, i.e. in particular in the ON state, a second brightness value of this measurement region results, defined by the associated average grayscale value. The second average grayscale value is at least 5%, preferably at least 10%, and in particular preferably at least 15%, higher compared with the first average grayscale value. The arithmetic mean of measured values of the reflection and/or of the reflected and/or scattered light in the first region is preferably at least 5%, preferably at least 10%, further preferably at least 15%, greater at the predefined first observation angle than at the predefined second observation angle. The difference of the measured value in the ON state less the measured value in the OFF state divided by the amount of the measured value in the OFF state is thus in particular at least 0.05, preferably at least 0.1, preferably at least 0.15.

At the predefined first observation angle, in particular the maximally strongest difference in brightness in the second region, preferably between background and absorption region, is greater than the maximally strongest difference in brightness in the second region, in particular between background and absorption region, at a predefined second observation angle, preferably wherein in partial regions of the item of personalized information, in particular absorption regions, the reflection is weaker than in the partial regions of the second region in which no absorption regions are present. This can in particular be ascertained with the described setup by ascertaining measured values of the corresponding regions.

In other words, it is possible for the brightness to be increased in the case of a change from the second predefined observation angle to the first predefined observation angle more strongly in the background region than in the absorption region.

A preferred embodiment, wherein the difference in brightness in the second region is stronger at a predefined first observation angle than at a predefined second observation angle, preferably means that the contrast in the second region, calculated from the ratio of the arithmetic mean of the measured values of the reflection in the absorption region to the arithmetic mean of the measured values of the reflection of the background region, has a lower value at the predefined first observation angle than at the predefined second observation angle.

It is also possible for the first security element to be designed such that an increase in a brightness, in particular in the second region, in the case of a change from an observation at the predefined second observation angle to an observation at the predefined first observation angle is smaller in the absorption region than in the background region.

It is also possible for the absorption region to have an optical density, at least in the first region at least in partial areas, with a maximum K value of 3, in particular measured according to ISO 13655:2017 (E). It is possible for the contrast between absorption region and background region in the second region to have at most a value of 0.1, preferably 0.15, at the first observation angle. At the predefined first observation angle, the contrast between the blackening of partial regions of the second region outside the absorption region and partial regions in the absorption region preferably lies in a range of from 0.1 to 3.

The optically variable effect of the first security element is preferably visible only when the first side is observed. It is possible for the security document, preferably when observed from the first side, to have a semi-transparent or opaque contrast layer behind the first security element to increase the contrast of the item of personalized information, in particular at an observation angle that is not the same as the first predefined observation angle, preferably at the second observation angle. The contrast layer preferably contains fillers, in particular TiO₂, for the preferably diffuse scattering of incident light. The contrast layer preferably has no optically variable effect. In particular, the core layer is coated with the contrast layer or represents the contrast layer. For this, the core layer can contain fillers, such as in particular TiO₂, and/or scatter white light, or have a pigmented white print on the surface. The security document is preferably semi-transparent or transparent, in particular is not opaque, between the absorption layer and the first security element.

The advantage can hereby be achieved that, in the case of a manipulation attempt, grinding away from the second side is made more difficult. In particular, it can be difficult for forgers to recognize, before damaging the first security element, that the first security element gives protection against grinding away from the second side.

It is also possible for the security document to comprise, in a third region, a second security element with an optically variable effect, which is arranged in front of the absorption layer when the first side is observed, in particular wherein the third region does not overlap the absorption region or overlaps it partially or over the whole surface. Preferably, the optically variable effect is not visible at the predefined first observation angle. Advantageously, the second security element can be outshone by the first security element at the predefined first observation angle. It is also possible for the first security element and the second security element to be visible, in particular to be visible with the human eye, preferably at different observation angles when the first side is observed. The advantage can hereby be achieved that checking for a manipulation attempt can be carried out quickly and easily from only one single side, namely from the first side.

It is preferred that the first security element and the second security element and in particular also the absorption region overlap in an overlap region. When the first side is observed, a security element with an optically variable effect is provided in each case in particular both in front of and behind at least a part of the absorption region. These two security elements preferably overlap at least partially, in particular in the case of a top view onto a plane spanned by the security document. The second security element, which lies in front of the absorption region, is preferably designed semi-transparent or transparent. Further preferably, the first and the second security elements are designed semi-transparent or transparent. Grinding away part of the surface and substituting an item of personalized information, for example, is thus made more difficult since at least one of the security elements would be damaged in the process in order to manipulate the whole item of personalized information.

It is also possible for the optically variable effect of the first security element and of the second security element to interact with each other, in particular such that a logical combination of the two planes, which is visible with the human eye and/or measurable and/or perceptible for the human observer, exists and thereby further increases the protection against forgery.

In particular, a combination of the first and second security elements is conceivable such that a backlighting of a partial metallization of the second security element is effected. It is hereby possible for the metallized regions to appear dark in contrast to non-metallized regions. This can be utilized, among other things, for design integration. For example, the partial metallization can have the shape of a house, wherein the windows are designed free from metal. When the second security element is backlit through the optical effect of the first security element the windows light up as if someone had switched on the light.

A combination of the first and second security elements is also conceivable such that a shadow of a partial metallization of the second security element is cast onto the reflective layer of the first security element. The partial metallization can have the shape of letters, for example. The greater the distance of the first security element from the second security element is, the more pronounced the movement of the shadow cast onto the reflective layer of the first security element is when the security document is tilted, in particular when the security document is tilted to the left and right or forward and backward.

A combination of the first and second security elements is also conceivable such that the partial metallization is designed in the form of a so-called revealer layer for Moiré effects, e.g. in the form of fine demetallized line or hole grids with a regular spacing of the lines or of hole centers or of hole edges, preferably with a spacing in a range of between 5 μm and 200 μm, and the line width or the hole diameter is preferably chosen such that at most 50%, preferably at most 30% and in particular preferably at most 20% of the light incident on the partial metallization passes through the line or hole grids. Further preferably, the optical effect of the first security element is formed in the shape of the Moiré pattern matching the line or hole grid, e.g. in the shape of lighting-up Moiré icons or similar microimages. Moiré-like magnification and/or movement effects can thus preferably be realized in the finished security document. The linked regions of the two security elements have been or are realized in particular one lying on top of the other here.

The hole size is preferably the same magnitude in the whole, partially metallized region. As a result, the brightness of the optical effect of the first security element is approximately the same. Alternatively, the hole size can vary in a targeted manner over the partially metallized region of the first security element, whereby e.g. brightness gradients can be generated and thus, for example, a fade-in or fade-out of the optical effect in the edge region of the partial metallization is achievable.

Further, it is possible for the first security element and/or the second security element to be designed semi-transparent and/or transparent, in particular to have a transmittance in the wavelength range visible to the human eye selected from the range of from 380 nm to 780 nm, preferably from 430 nm to 690 nm. It can hereby advantageously be achieved that, even in the OFF state or at the predefined second observation angle, a large amount of design freedom can be guaranteed the security document for optical effects in the background region and, for example, further items of information or decorations can be shown on the first side behind the first security document or a high-contrast substrate can be provided for the absorption region, in particular by means of the core layer or layers printed thereon. An in particular fine-lined security print and/or in particular optically variable effect pigments, which for example fluoresce under UV irradiation or light up under IR radiation, are particularly preferred. A further advantage compared with opaque, in particular metallic, security elements is that, in the case of a semi-transparent and/or transparent design, the first security feature is hardly or not visible in the OFF state, whereby, in the case of a change into the ON state, a surprising effect is achieved for the observer, which advantageously increases the protection against forgery further.

It is also possible for the second security element to be designed opaque, in particular to have a transmittance selected from the range of from 0.1% to 30%, preferably from 1% to 10%, in the wavelength range visible to the human eye.

The absorption region is preferably arranged in register, preferably in perfect register or without register tolerance, with the background region. As already described above, with this an improved protection against forgery can be achieved and the checking for authenticity can be simplified.

It is also possible for the security document to have a window region in which the core layer is preferably transparent or omitted. An absorption region for the formation of a further item of optical information, in particular a further item of personalized information, preferably has been or is introduced in the record layer at least partially in the window region. When the first side of the security document is observed, a third security element or a further region of the first security element is preferably arranged behind the further item of optical information. The recognizability of the further item of optical information in reflected light can hereby be designed to be low because a contrasting, for example “white”, background is lacking. Through the third security element or the further region of the first security element, a backlighting of the further item of optical information at a further predefined angle can be achieved and thus in particular the further item of optical information can be easily checked by “switching on and off”. The further region of the first security element is preferably designed here just like the first security element in the second region.

The first security element and/or the second security element in particular have a carrier, in particular comprising or consisting of PET or PEN. The carrier preferably has a layer thickness in a range of from 5 μm to 150 μm, further preferably from 5 μm to 50 μm, still further preferably from 10 μm to 25 μm.

It is also possible for the first security element and/or the second security element to have at least one replication layer, in particular wherein the at least one replication layer has a layer thickness in a range of from 0.2 μm to 20 μm, preferably from 0.2 μm to 10 μm.

It is also possible for the first security element and/or the second security element to have at least one reflective layer with a preferred layer thickness in a range of from nm to 200 nm, further preferably from 40 nm to 100 nm. It is possible for the reflective layer to preferably consist of a material with a refractive index which differs from the refractive index of the replication layer by at least 0.2. The reflective layer preferably comprises or consists of a metal layer or a high-refractive-index layer (=HRI layer, layer with a high refractive index) or combinations thereof. Preferred materials of an HRI layer are, for example, ZnS and/or TiO₂. The reflective layer thus preferably comprises ZnS or TiO₂ or in particular consists of ZnS or TiO₂. The HRI layer can comprise or consist of materials selected individually or in combination from SiOx, MgO, TiOx, Al₂O₃, ZnO, ZnS. The variable x preferably lies in the continuous range of from 1 to 3. The reflective layer can comprise or consist of the following metals individually or in combination: chromium, aluminum, gold, copper, tin, indium, silver and an alloy of one or more of the above metals. The thicknesses of the metal layers lie in particular in the range of 10 nm to 200 nm, preferably from nm to 100 nm. It is also possible for the reflective layer preferably to contain one or more metal oxides, selected individually or in combination from aluminum oxide, chromium oxide, silicon oxide, indium tin oxide, titanium oxide and combinations thereof. In the case of an HRI layer, the reflective layer preferably has a refractive index of more than 1.9 in the wavelength range visible to the human eye, preferably in the wavelength range of from 420 nm to 780 nm.

The reflective layer is in particular arranged over part of the surface or over the whole surface in the security document and/or in the first security element and/or in the second security element, in particular wherein the reflective layer has different layer thicknesses at least over part of the surface.

The first security element and/or the second security element preferably has a detachment layer. The detachment layer ensures, in particular during the application, that the layer composite of the transfer plies is detachable from the carrier ply of a transfer film. The detachment layer is in particular arranged on a side of the security element facing away from the adhesive layer or the stabilizing layer. When the security element is laminated into a layer composite, the detachment layer can additionally bring about a good adhesion to an adjacent polycarbonate ply or to an adjacent PVC ply (PVC=polyvinyl chloride) or to an adjacent PET ply or to an adjacent adhesive layer. The thickness of this detachment layer lies in the range of 0.2 μm to 10 μm, preferably in the range of 0.2 μm to 5 μm. Thicknesses of the optionally present wax layers lie in the range of from 1 nm to 50 nm. The detachment of the carrier ply of the transfer film can additionally be improved through one or more thin wax layers. One or more of the one or more wax layers can remain on the detachment layer in the security document and/or one or more of the one or more wax layers can be detached with the carrier ply.

It is also possible for the first security element and/or the second security element to have one or more functional layers, which are arranged between the detachment layer and the reflective layer. Such a functional layer can be a stabilizing layer, which has a stabilizing mechanical effect against degradation during the laminating, in particular between further layers made of polycarbonate (PC) or polyvinyl chloride (PVC). The stabilizing layer has been or is preferably thermally stabilized, in particular by crosslinking by means of radiation, in particular UV radiation, or by means of a chemical reaction.

It is also possible for the first security element and/or the second security element to have at least one stabilizing layer with a preferred layer thickness in a range of from 0.5 μm to 20 μm, further preferably from 1.0 μm to 10 μm, wherein the stabilizing layer in particular is single-layered or multi-layered and preferably comprises an adhesion-promoter layer. The stabilizing layer is in particular arranged on a side of the replication layer facing away from the detachment layer.

It is also possible for the first security element and/or the second security element to have at least one adhesive layer with a preferred layer thickness in a range of from 0.2 μm to 20 μm, further preferably 0.2 μm to 10 μm, in particular wherein the adhesive layer is formed of hot-melt adhesive or cold glue, and wherein the adhesive layer is preferably designed single-layered or multi-layered. The adhesive layer is in particular arranged on a side of the replication layer facing away from the detachment layer, in particular arranged on a side of the stabilizing layer facing away from the detachment layer.

It is also possible for the first security element and/or the second security element, in particular in the reflective layer and/or the replication layer, to have at least one relief structure, wherein the at least one relief structure deflects, in particular diffracts and/or reflects, the incident light in predetermined angle ranges.

In a preferred embodiment, the first security element appears achromatic in the second region, in particular in the background region, when observed at the predefined first observation angle. Expediently, the first security element preferably has microstructures with an achromatic appearance. Examples of microstructures with an achromatic appearance are, for example, diffraction gratings, in particular blazed gratings or diffraction structures with a grating period of more than 3 μm, in particular more than 5 μm, isotropically or anisotropically scattering matte structures, light-reflecting micromirrors or facets as well as white-light-diffracting computer-generated holograms (CGH).

It is also possible for the first security element to be semi-transparent or transparent in the second region when the first side is observed at the predefined second observation angle.

It is further preferred that the first security element appears achromatic at least in a first partial region of the absorption region, which forms a grayscale image or a multicolored image, preferably a portrait, when observed at the predefined first observation angle. It is possible for the first security element, in particular the second region, to form only a partial region of the first side of the security document. It is preferably also possible for the first security element to be arranged partially overlapping or overlapping the whole surface of at least one first partial region of the absorption region, which forms a grayscale image or a multicolored image, preferably of a portrait, in a closed and coherent region with a minimum width and/or minimum length of 80%, preferably 100%, of a region provided for the first partial region of the absorption region. In particular, the provided region is a defined region for the portrait in a security document. The second region, which is formed at least by a partial region of the absorption region and a partial region of the background region directly adjoining it, preferably has the outline of a portrait or of a frame around a portrait. The maximum width and/or the maximum length of the closed and coherent region is preferably 110% of the provided region of the first partial region of the absorption region.

It is also conceivable that the first security element has further regions separate from the second region and in particular differently designed regions. It is further possible for the second region, which is formed at least by a partial region of the absorption region and a partial region of the background region directly adjoining it, to have a width in a range of from 10 mm to 50 mm and a length in a range of from 15 mm to 70 mm. Through the above-named properties, in particular the viewing-angle-dependent contrast can be allocated to the item of personalized information, with the result that the first security element is not perceived merely as a standalone motif. In particular, it can be achieved that the absorption region is intuitively perceived as optically variable as a portrait together with the first security element. Furthermore, checking for authenticity is improved since in particular an achromatic effect, which preferably forms a type of backlighting of a portrait, can be checked particularly easily by the human eye and even by lay people and, as already described above, a perfect register is difficult to fake.

The first security element is preferably colored, particularly preferably multicolored, in a fourth region, wherein the fourth region overlaps, in particular in regions, a second partial region of the absorption region, which is preferably formed of alphanumeric characters. The protection against forgery can be further improved hereby since the backlighting is preferably partially not present, with the result that regions with additionally complex security elements can be provided, with the result that on the one hand the portrait can be easily checked and at the same time the front side is difficult to fake.

It is advantageously possible for the first security element to have substantially achromatic optically variable effects at least in partial regions, preferably in the second region. These have the advantage that they increase the contrast with the absorbing, preferably black-absorbing, at least one item of personalized information, at least at the predefined first observation angle and behave color-neutrally, unlike colored optically variable effects. This is advantageous in particular when overlapping portraits by means of blackening and/or black printing and/or color printing, since color effects are, if anything, perceived by the observer as disrupting or confusing there, with the result that here a particularly simple checking by an observer can be made possible.

The first security element preferably has achromatic effects selected individually or in combination from:
effects lighting up white through tilting, in particular through tilting forward and backward and/or tilting to the left and right, preferably wherein the first security element lights up white, preferably lights up homogeneously white, at the predefined first observation angle, and does not light up white, in particular is semi-transparent or transparent, at the predefined second observation angle;
achromatic brightness patterns, such as for example brightness bands, which move, in particular move linearly or radially or in a more complex shape, when the security document is tilted, in particular when tilted forward and backward and/or to the left and right;
icons lighting up white or dark icons on a background lighting up white, which move when the security document is tilted, in particular toward the left and right and/or up and down, preferably float virtually in front of or behind the plane of the security element and in particular are recognizable when illuminated with a point light source, preferably wherein by icon is preferably meant a two-dimensional or flat object such as a motif, for example one or more letters, a logo or a barcode;
achromatically appearing convexly or concavely curved lens shapes or freeforms, which preferably appear to jump virtually in front of or behind the document plane.

Such achromatic optically variable effects can be generated with different types of microstructure, for example by means of grating structures, preferably blazed gratings, with a grating period of more than 3 μm, in particular more than 5 μm, or by means of computer-generated holograms or by means of micromirrors or by means of Fresnel lens structures or by means of matte-scattering structures or by means of light-directed diffractive structures.

The at least one relief structure of the first security element is advantageously a blazed structure, in particular with a grating period of more than 3 μm, further preferably more than 5 μm, and in particular at most 25 μm, and/or is in a range of from 3 μm to 25 μm. The first security element preferably has blazed structures with an angle range for the inclination a in the range of from 0 to 40 degrees, preferably in the range of from 3 to 30 degrees, further preferably in the range of 5 to 25 degrees. The reflective layer of the first security element is preferably formed by an HRI layer (HRI: high reflective index). Preferably, a layer thickness of the HRI layer is in particular in a range of from 30 nm to 280 nm, preferably of from 50 nm to 120 nm.

It is also possible for the first security element to show an in particular achromatic movement sequence in the first region when the first side is observed at the first predefined observation angle. In particular, the preferably achromatic movement sequence is visible by tilting the security document. For this, blazed structures or micromirrors can be used, which in particular have a varying azimuthal angle, thus in particular a varying orientation, or wherein the period of the blazed structure or the flank angle of the micromirrors varies.

It is also possible for the first security element to have element regions, in particular to have them with dimensions below the resolving power of the human eye, preferably when the first side is observed at a distance in a range of over 30 cm, wherein relief structures which differ from the relief structures of the surrounding regions of the first region and in particular are motif-shaped are provided in the element regions. The maximum width of the element regions preferably lies in a range of from 2 μm to 250 μm. The surface coverage of these elements is preferably less than 25%.

The first security element in the form of preferably extensive patches, optionally with cutouts, which in particular serve as bonding bridges, preferably has been or is arranged behind a portrait, and partially behind further items of personalized information, in particular personalized data, when the first side is observed. A first security element partially arranged in the security document thus in particular has interruptions as bonding bridges for the surrounding layers. It is in particular also possible for the first security element to be present over the whole surface in the security document. In other words, the first region preferably comprises the whole security element.

It is further possible for the first security element to have been or to be arranged in several separate regions or for the first security element and further security elements to have been or to be arranged in the same plane. For this, the first security element, or the first security element and the further security elements, has been or is is applied to the same layer, which is preferably the core layer or a cover layer, preferably the first cover layer, in particular directly or indirectly via further layers. The security elements or the several separate regions of the first security element further preferably come from one and the same transfer ply of a transfer film during the application. In particular, the register accuracy of the applied security elements relative to each other can hereby be improved. Alternatively, each region and/or each security element is provided and applied with its own separate transfer film.

It is also possible for the first and/or second security element preferably to comprise a diffractive grating. Such a diffractive grating is preferably selected individually or in combination from: linear grating, crossed grating. The diffractive grating preferably has a grating period in a range of from 200 nm to 10 μm. The diffractive grating in particular has a grating depth in a range of from 50 nm to 2 μm, preferably between 80 nm and 1.5 μm. A diffractive grating with grating periods of less than 500 nm and preferably less than 400 nm is further conceivable. These are subwavelength gratings which have color impressions and/or color effects in the zero diffraction order, thus in particular in direct reflection, when these gratings are provided with a high-refractive-index layer or with a metallic layer. If the gratings are provided with a high-refractive-index layer, in particular the so-called RICS color effect forms. If the gratings are provided with a metallic layer, e.g. aluminum, then in particular plasmonic color effects form. The absorption region advantageously contrasts well with the color impression of a diffractive grating, as a result of which the items of personalized information are easier for the observer to check than the personalizations previously known in the state of the art without a security element lying behind them.

The first security element preferably has a partial metal layer as reflective layer in regions outside the absorption region. As a result, striking and easily checkable effects can be generated without, for example, a laser destroying the metal layer.

The at least one item of personalized information has been, in the security document, or is, in the production method, preferably formed by means of manipulation of the absorption layer with a laser, in particular through a blackening, and/or through a printed layer comprised or formed by the absorption layer in particular by means of printing. A blackening can have different intensities corresponding to the energy introduced and/or have been or be introduced in the manner of a grid, with the result that for example grayscales can also be implemented. In particular, an item of personalized information in the form of a portrait has been or is preferably formed by means of blackening and/or black printing and/or color printing. By background region is preferably meant a partial region of the first region in which no printing or no manipulation by means of lasers is arranged.

The absorption layer comprises or consists in particular of polycarbonate (PC) or polyvinyl chloride (PVC), in particular if it is a laserable absorption layer. The absorption layer is preferably transparent outside the absorption region. It is also possible for the absorption layer to be transparent in the absorption region before the at least one item of personalized information was formed. The absorption layer can preferably be written on or is written on by means of lasers with a wavelength of approximately 1064 nm.

It is also possible for a further absorption layer to be arranged behind the first security element when the first side is observed. It is preferably possible here for the at least one item of personalized information to be composed of the absorption layer and the further absorption layer in the OFF state or when observed at the second observation angle.

It is possible for the second region to be formed by the first region. It is also conceivable that the first region has further regions, which do not overlap the second region. It is also possible for the contour of the second region to form a frame of a first item of personalized information of the at least one item of personalized information, in particular around a portrait.

It is possible for the security document to have further security elements, such as the third security element, for which in each case the above-named observation angles can be defined independently of each another, with the result that for example a first observation angle allocated to the first security element can mean a different observation angle of the security document than an observation of the third security element at its first predefined observation angle.

It is further possible for the security document to have at least one preferably opaque core layer. It is also possible for the security document to have at least one preferably transparent cover layer on the first side and/or on the second side.

The security document preferably has one or more of the following layers, in particular in the specified order from the first to the second side:
in particular transparent first cover layer comprising or consisting of polycarbonate (PC) or polyvinyl chloride (PVC),
second security element partially arranged between the first cover layer and the absorption layer
absorption layer comprising or consisting of polycarbonate (PC) or polyvinyl chloride (PVC),
first security element partially arranged between the absorption layer and the core layer
in particular opaque core layer comprising or consisting of polycarbonate (PC) or polyvinyl chloride (PVC)
in particular transparent second cover layer comprising or consisting of polycarbonate (PC) or polyvinyl chloride (PVC).

It is also possible for the security document to have one or more of the following layers, in particular in the specified order from the first to the second side:
preferably whole-surface second security element, which in particular forms a transparent outermost layer of the security document and has at least one relief structure with a preferably diffractive optically variable effect due to a difference in refractive index at the relief structure
in particular transparent first cover layer comprising or consisting of polycarbonate (PC) or polyvinyl chloride (PVC),
absorption layer in the form of a printed layer arranged in regions between the cover layer and/or a substrate
substrate, in particular selected individually or in combination from paper, teslin, PVC, ABS, PET and composite.

It is possible for the second security element preferably to be present in the system for producing the security document over the whole surface in the second partial element and to comprise a reflective layer in the form of an HRI layer, in particular wherein a relief structure with a diffractive optical effect is molded in the reflective layer.

The second security element can preferably also be an almost whole-surface second security element, which covers more than 80%, preferably more than 90%, of the surface of the security document, preferably of the visible surface when the first side is observed, and/or of the second partial element.

It is also possible for a fold edge to be arranged between the first partial element of the security document and the second partial element of the security document, wherein the fold edge separates the first partial element of the security document and the second partial element of the security document in such a way that the partial elements can be made to overlay by folding at the fold edge or are made to overlay during the production method.

It is also possible for the fold edge to be present in a region in which neither the first nor the second carrier element is provided or for first and second carrier element to be formed by a layer which separates the first and second partial elements by a weak point, in particular an indentation, a scoring or a perforation, which form the fold edge, connects.

It is also possible for the first security element to be arranged in the first partial element of the security document on the side of the first carrier element facing away from the auxiliary carrier. It is also possible for the second security element to be arranged, preferably over part of the surface or over the whole surface, in the second partial element of the security document between carrier element and adhesive layer.

It is also possible for at least one carrier layer to be arranged in the first partial element and/or in the second partial element on a side facing the auxiliary carrier, wherein the carrier layer in particular consists of PET or comprises PET.

It is also possible for the second partial element of the security document to have a protective layer, wherein the protective layer is arranged on the side of the adhesive layer facing away from the carrier element. The protective layer is in particular detachable from the adhesive layer and in particular consists of silicone or comprises silicone. The protective layer is preferably comprised by the covering.

It is also possible for the following step to be carried out, in particular before or after the arranging of the absorption layer and the first security element:
introducing the at least one item of personalized information. The introduction of the at least one item of personalized information is preferably carried out by means of a laser by blackening the absorption layer, and/or by printing the absorption layer.

It is also possible for example for the security document to have been or to be joined by means of laminating to form a firm layer composite.

A laminating for producing the security document or for joining the absorption layer to a core layer of the security element preferably has been or is carried out by means of a pressure of from 10 N/cm² to 400 N/cm², preferably 40 N/cm² to 200 N/cm², is exerted on at least one or more layers selected from absorption layer, first security element, second security element, core layer, cover layer, in particular first and/or second cover layer. It is possible for the laminating to be or to have been carried out by means of a temperature of more than 150° C., preferably between 160° C. and 210° C., which, from a heat source, in particular from one or more of the heated rollers or one or more of the heated plates, acts on at least one or more layers selected from absorption layer, first security element, second security element, core layer, cover layer, in particular first and/or second cover layer. The laminating preferably is or has been carried out by means of a contact time of the heat source with at least one or more layers selected from absorption layer, first security element, second security element, core layer, cover layer, in particular first and/or second cover layer, in a range of from 1 minute or more and 30 minutes or less. In the process, the contact of the heat source with one or more of the above-named layers is preferably effected directly or indirectly via further layers. The above settings are preferably to be used for a core layer, an absorption layer and a cover layer, in particular first and second cover layer, consisting of or comprising polycarbonate. For other materials, such as for example polyvinyl chloride, settings with respect to temperature and pressure differing from this and matched to the materials to be processed can be used.

For producing the security document it is possible in particular for the arranging to be carried out in that, preferably after a lamination and/or a gluing of the layers of the security document, a blackening is introduced by means of lasers in the absorption region, and/or to be carried out in that a first partial element, in particular of the system according to the invention, which has the first security element, has been or is provided with a printed layer as absorption layer and is preferably then joined to further layers of the security element, in particular the second partial element, by gluing, in particular by bending the system. Thus, the following step, which is in particular carried out during the arranging, is also conceivable:
bending the system such that the first partial element and the second partial element are made to overlay and the at least one item of personalized information has a viewing-angle-dependent contrast in a second region, which is formed at least by a partial region of the absorption region and a partial region of the background region directly adjoining it.

In the following, the invention is explained by way of example with reference to several embodiment examples with the aid of the accompanying drawings. The embodiment examples shown are therefore not to be understood as limitative.

FIGS. 1a, 1b, 1c, 1d, 1e, 1f, 1g, 1h, 1i show schematic representations of a cross section of security document.

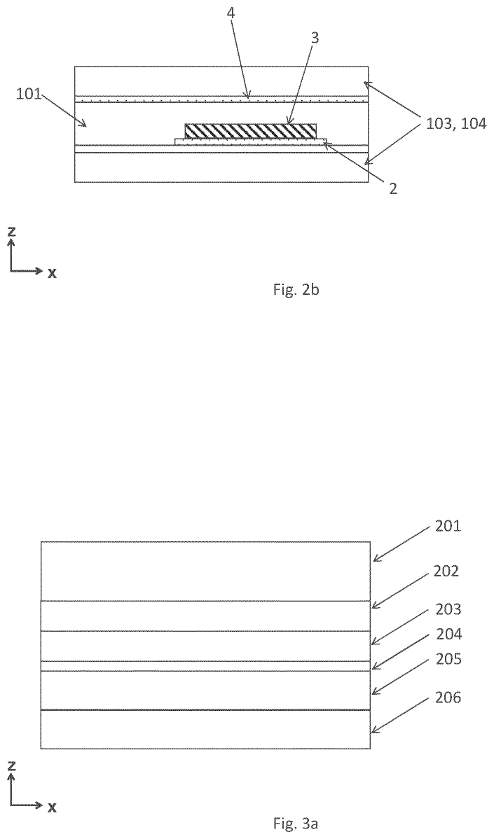

FIGS. 2a and 2b show a schematic representation of a system for producing a security document and a security document produced therewith.

FIG. 3a shows a schematic representation of a transfer film.

FIG. 3b shows, schematically, a security element in cross section.

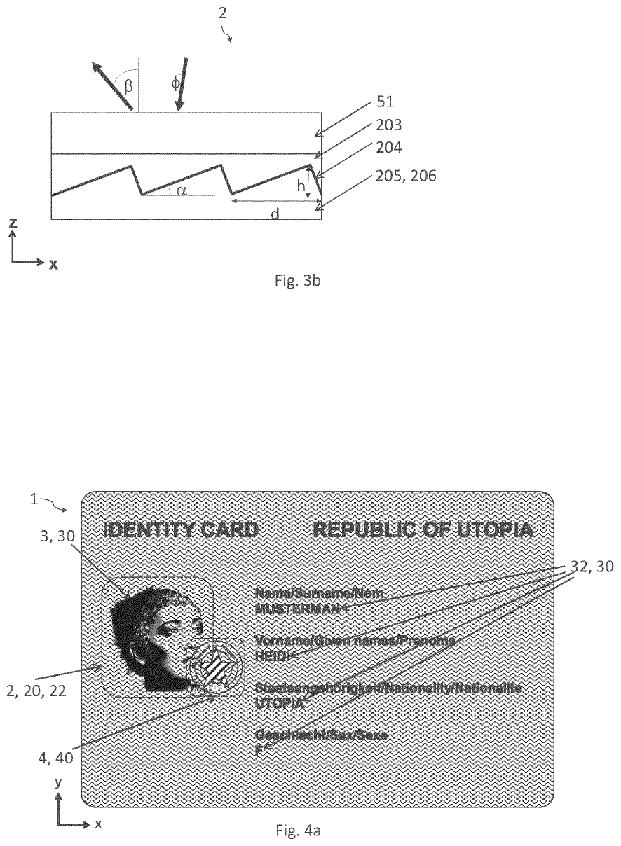

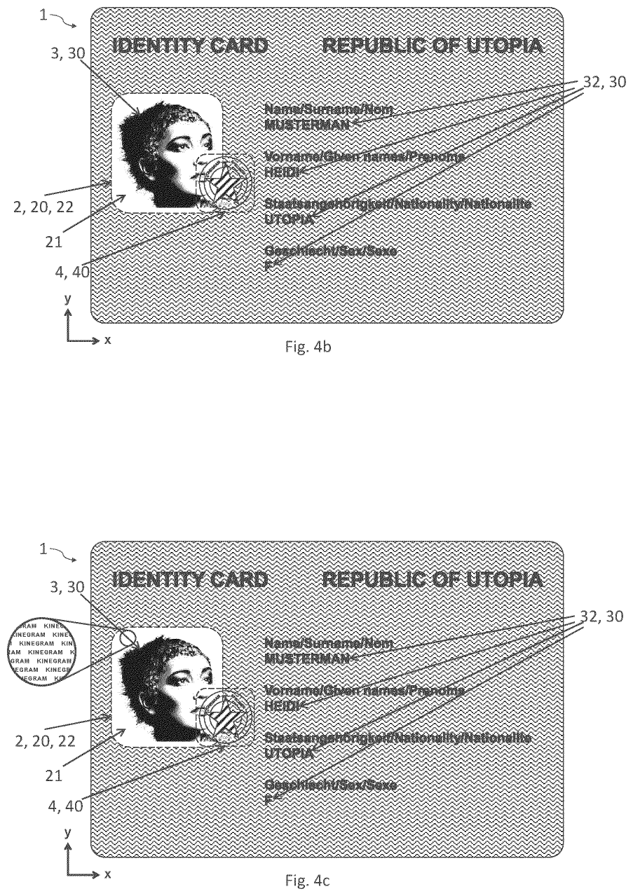

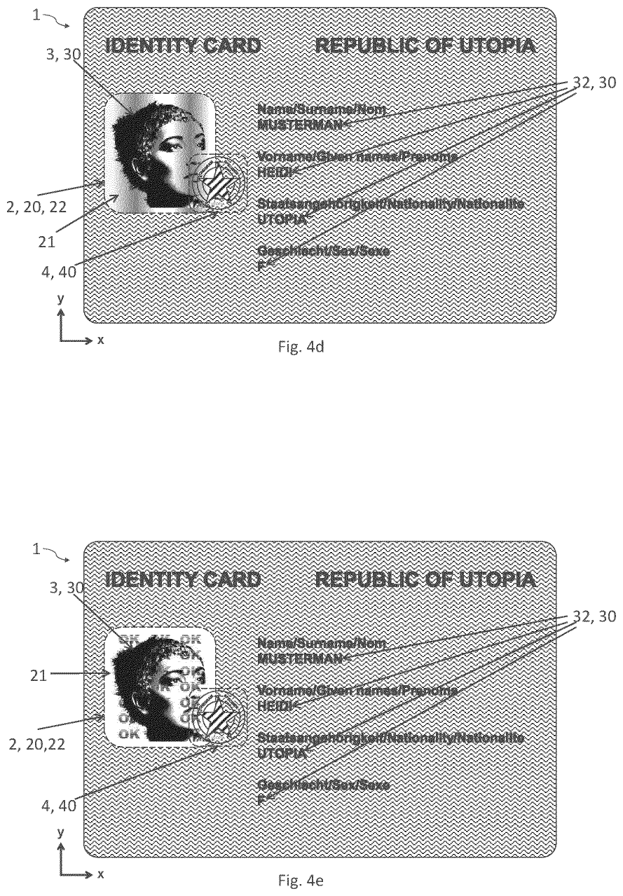

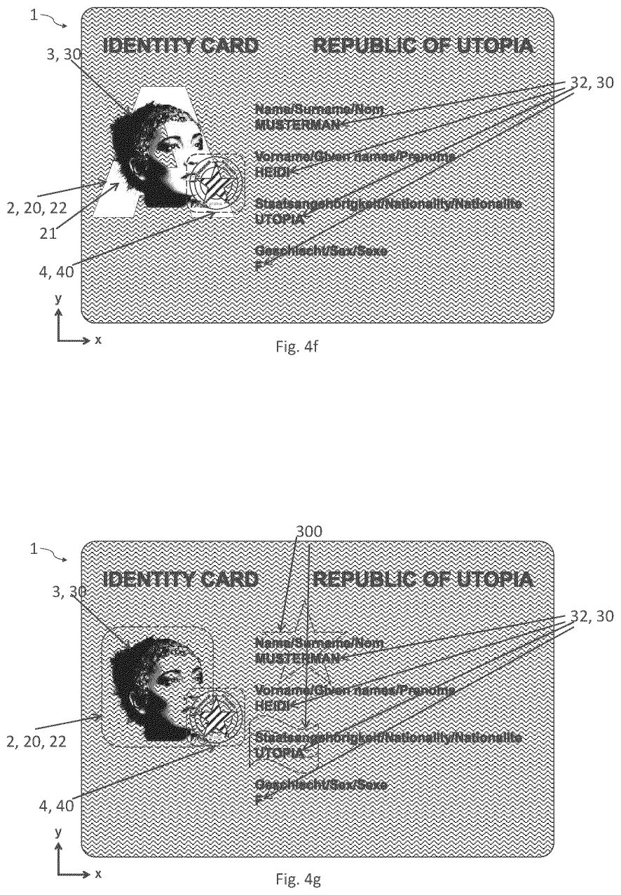

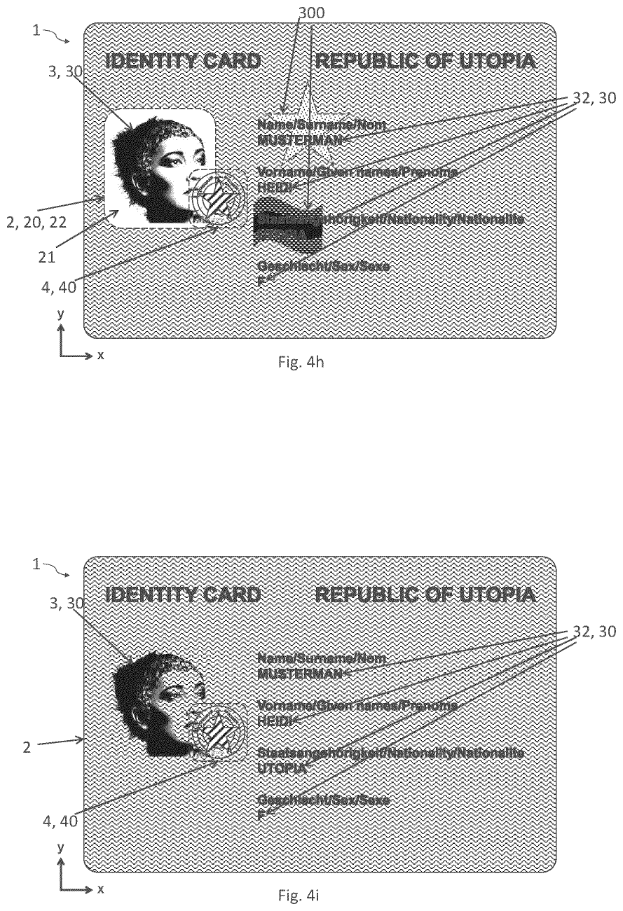

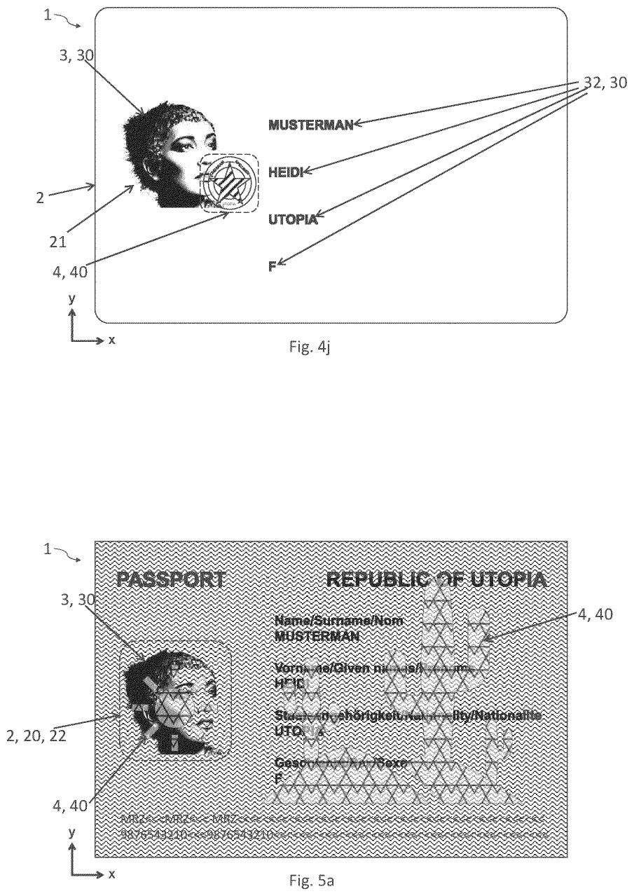

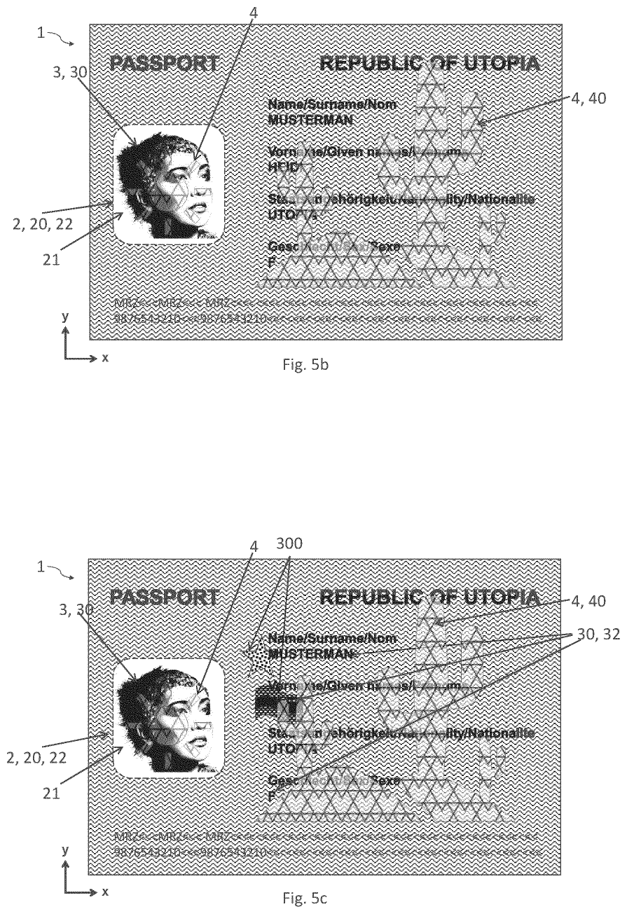

FIGS. 4a, 4b, 4c, 4d, 4e, 4f, 4g, 4h, 4i, 4j, 5a, 5b, 5c, 5d, 5e, 5f show schematic representations of an observation of the first side of a security document.

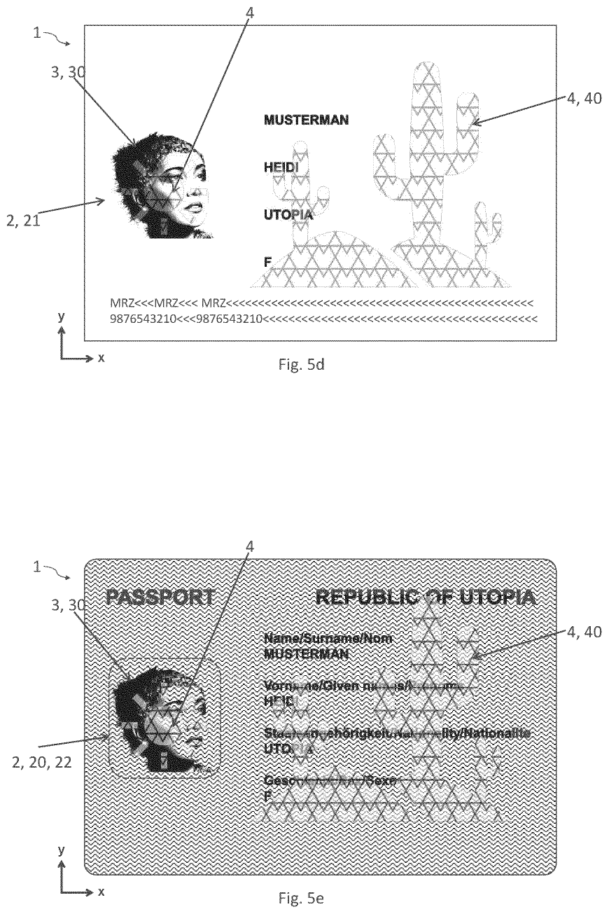

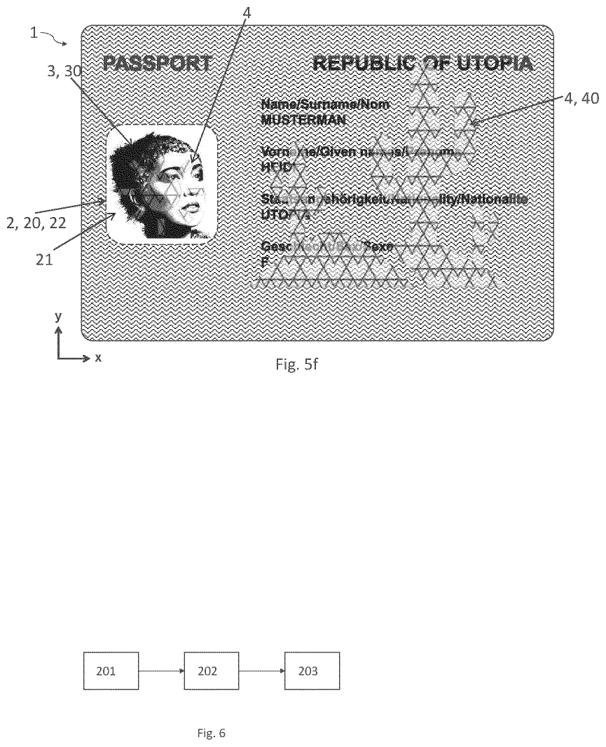

FIG. 6 shows by way of example a method for producing a security document.

FIG. 1a to FIG. 1i show schematic cross sections of different structures of a security document 1. They are preferably cards based on plastic. A security document 1 based on plastic preferably consists of several layers, which preferably have been or are joined together in a laminating process. The total thickness of the security element after the lamination is preferably designed according to standard specifications. In the case of card-based ID documents (ID-1 format), they are in particular approximately 780 μm in accordance with ISO/IEC 7810:2019. Advantageously, the individual layers consist of a similar material, such as for example of polycarbonate (PC) or of polyvinyl chloride (PVC), with the result that a stable and approximately homogeneous composite body is formed after the lamination. However, different materials can also be joined to each other, possibly with the aid of one or more adhesive layers, for example made of polyurethane, or a heat-sealable adhesive. Such adhesives can also be post-crosslinking, with the result that they do not melt again under the action of heat.

FIG. 1a shows by way of example a first structure of a security document 1 in cross section, preferably with a substantially opaque core, which is usually pigmented white. The core is in particular formed by the core layer 55. The core layer 55 is preferably arranged in the middle. Transparent layers are attached to the core layer 55, in particular on top and underneath, such as layer 54 and 56 in this example. However, the core layer 55 can also include transparent zones, which can be utilized as window regions, as can be seen in FIG. 1h for example. Optional electronic components, such as for example RFID antennas and chips, which can be located in the core layer 55, are not represented. The core layer 55 can be made up of several layers and it is possible for the core layer 55 not to be composed of a homogeneous material.

Several transparent layers, one of which is designed as absorption layer 52, in particular in the form of a laserable layer, are also represented in FIG. 1a. In the absorption layer 52 of the security document 1, preferably for the formation of the at least one item of personalized information 3, a blackening can thus be performed in particular by means of laser radiation. The extent of the blackening can in particular be influenced by the chosen laser parameters. In FIG. 1a, the blackening is indicated only in the region 30 on top of the first security element 2, further items of personalized information can also be located outside this region but are not explicitly drawn in.

The at least one item of personalized information 3 can also be effected by means of a printing procedure, for example on a layer on top of the first security element 2, as is described for example in relation to one of FIGS. 1f, 2a, 2b as well as FIGS. 5a to 5d, or be sealed directly onto the first security element 2 and in particular by means of lamination with further layers.

A combination of an absorption layer 52, in particular with a blackening by means of laser personalization, joined to a colored print on a further layer of the security document 1 or on the surface of the security document 1, is also possible. Besides the second security element 4 or in place of the second security element 4, a further security element with an optically variable effect can be applied to the surface of the security document.

FIG. 1a shows, schematically, a cross section of an example security document 1. A security document 1 as described in relation to FIG. 1a and FIG. 1b can preferably have the appearance shown schematically in FIG. 4b at the first observation angle, in particular in the ON state, and have the appearance shown schematically in FIG. 4a at the second observation angle, in particular in the OFF state, wherein FIG. 4a shows yet further partial regions of the absorption region 30 with further items of personalized information 32, by way of example in the form of alphanumeric characters.

Regions, overlaps, widths and lengths are in particular to be observed in top view, as can be seen in FIG. 4, and from top to bottom on the first side in FIG. 1.

The first security element 2 is in particular contained in the security document 1 in patch form. A security element in patch form has been or is in particular introduced into the multi-layer structure, e.g. by gluing to the record layer 52 or to the transparent layer 54 or to the core layer 55, before the layers of the security document 1 are joined, preferably by lamination. The first security element 2 is preferably implemented transparent, in particular with ZnS as HRI layer, and is preferably located between the absorption layer 52 and the core, in particular the core layer 55, further preferably between the absorption layer 52 and a printed layer, which is preferably printed by means of offset printing. The printed layer is in particular a layer printed onto the transparent layer 54 or a layer printed onto the core layer 55.

The security document 1 comprises a first side, which would be visible in FIGS. 1a and 1b when observed from top to bottom and is shown for example in FIG. 4a and FIG. 4b, as well as a second side lying opposite the first side. The security document 1 further comprises an absorption layer 52 with an absorption region 30 for the formation of at least one item of personalized information 3.

The security document 1 has been processed in the absorption region 30 such that the at least one item of personalized information 3 is visible, in particular visible to the human eye, through absorption of light incident on the first side. Alternatively or additionally, it is in particular also possible for the security document 1 to be able to be processed in the absorption region 30 such that the at least one item of personalized information 3 is visible, in particular visible to the human eye, through absorption of light incident on the first side.

The security document 1 additionally comprises the first security element 2 with an optically variable effect, as is illustrated by way of example by FIGS. 4a and 4b. In the case of observation of the first side, the first security element 2 is arranged behind the absorption layer 52 and the first security element 2 is arranged in a first region 20, wherein the first region 20 overlaps the absorption region 30 for example over the whole surface. It is also possible for the first region 20 to overlap the absorption region 30 over only part of the surface. The first region 20 does not overlap the absorption region 30 with a background region 21 directly adjacent to the absorption region 30, such that the at least one item of personalized information 3 has a viewing-angle-dependent contrast, in particular brightness contrast, further preferably difference in brightness, in a second region 22, which is formed at least by a partial region of the absorption region 30 and a partial region of the background region 21 directly adjoining it. In the example of FIG. 1a, the second region 22 preferably completely comprises the absorption region and the background region.

As can furthermore be seen in FIGS. 1a and 1n particular FIG. 4a, the first security element 2 is in particular semi-transparent or transparent in the second region 22 when the first side is observed at the predefined second observation angle. In particular, the change into the ON state, which FIG. 4b shows for example, can thus be perceived as an increase in the brightness of the background of the item of personalized information 3 or of the background region 21, which is associated with an accentuation and better recognizability of the item of information for the observer.

FIG. 1a shows by way of example a security document 1 with a cover layer 51, which is preferably transparent. The cover layer 51 comprises or consists in particular of PC or PVC. When the first side is observed, the absorption layer 52 is arranged under the cover layer. The optional second security element 4 is arranged between the cover layer 51 and the absorption layer 52 in regions partially overlapping the absorption region 30 and partially not overlapping the absorption region 30. Furthermore, the security document 1 shown in FIG. 1a has further optional transparent layers 53, 54 and 56, which in particular consist of PC or PVC or comprise PC or PVC. The transparent layer 53 is arranged between the absorption layer 52 and the transparent layer 54. The first security element 2 is arranged between the transparent layer 53 and the transparent layer 54. The core layer 55, which is preferably opaque, is arranged under the layer 54. The core layer 55 comprises or consists in particular of PC or PVC. A further transparent layer 56 is in particular arranged under the core layer 55. The layer 56 comprises or consists in particular of PC or PVC. When the second side of the security element is observed, thus from bottom to top in FIG. 1a, the core layer 55 is thus visible for example. The core layer 55 or one or more of the layers 51 to 54 can be printed on, for example, with one or more printed layers, which are visible from the first side in particular in the OFF state of the first security element 2. The core layer 55 or the layer 56 can, for example, also be printed on with a printed layer visible from the second side. It is also conceivable that the security document 1, preferably when observed from the first side behind the first security element 2, has a semi-transparent or opaque contrast layer to increase the contrast of the item of personalized information 3, in particular at an angle that is not the same as the first predefined angle, wherein the contrast layer preferably contains fillers, in particular contains TiO₂, for the preferably diffuse scattering of incident light. The contrast layer can preferably be applied over the whole surface for example between the core layer 55 and the layer 54. The contrast layer preferably has no optically variable effect.

It is possible for the security document 1 to have one or more prints. Printing methods used are, for example, offset printing and/or digital printing, in particular for the graphic design and/or as a security feature, as well as screen printing, in particular for special effect inks, such as for example OVI™ or metallic pigments. One or more prints can be attached to the core layer 55. It is also possible for one or more prints to be attached to the outside or inside of one or more layers, which are arranged between the transparent layers 51 and 56. Such prints are advantageously distributed on different layers.

The optically variable effect of the first security element 2 is in particular visible only when the first side is observed, thus from top to bottom in FIG. 1a or when observed as shown in FIG. 4b, wherein a predefined first observation angle, in particular in relation to a light source, prevails.

The security document 1 is preferably semi-transparent or transparent, in particular not opaque, between the absorption layer 52 and the first security element 2. Advantageously, in particular because of strong absorption of incident light in parts of the absorption region 30, the optically variable effect of the first security element 2 is not visible or hardly visible in the absorption region 30 when the first side is observed by the human eye. In particular, a perfect register or an arrangement without register tolerance between the contour of the absorption region 30 and the background region 21 adjacent to it can hereby be achieved. The absorption region has been or is preferably arranged in register with the first security element 2, with the result that there is in particular also a register-accurate arrangement with respect to the contours of the optically variable effect.

As FIG. 1a shows, it is also possible for the security document 1 to comprise, in a third region 40, a second security element 4 with an optically variable effect, which is arranged in front of the absorption layer 52 when the first side is observed, in particular wherein the third region 40 partially overlaps the absorption region 30. As FIG. 1f shows by way of example, a whole-surface, or in particular almost whole-surface, second security element 4 is also conceivable, which preferably covers more than 80%, further preferably more than 90%, of the surface of the security document 1, preferably of the visible surface, when the first side is observed. It is also possible for the first security element 2 and the second security element 4 to be visible, in particular to be visible with the human eye, when the first side is observed, as can be seen for example in FIGS. 4 and 5. The first security element 2 and the second security element 4 and in particular also the absorption region 30 preferably overlaps in an overlap region. In this way, parts of the absorption region, in particular in the form of a portrait, are located embedded between the first and the second security element, with the result that, advantageously, a forgery attempt from the front and from behind is made more difficult.

The first security element 2 and the second security element 4 can in particular be designed as described in more detail in relation to FIGS. 3a and 3b.

In a preferred design, the optical effects of the first and second security element 2, 4 interact with each other, with the result that a visible and/or measurable combination of the two planes of the respective security elements is realized. Examples of such a combination are:

A combination of the first and second security elements is also conceivable such that the partial metallization is designed in the form of a so-called revealer layer for Moiré effects, e.g. in the form of fine demetallized line or hole grids with a regular spacing of the lines or hole centers or hole edges, preferably with a spacing in a range of between 5 μm and 200 μm, and the line width or the hole diameter is preferably chosen such that at most 50%, preferably at most 30% and in particular preferably at most 20% of the light incident on the partial metallization passes through the line or hole grids. Further preferably, the optical effect of the first security element is formed in the shape of the Moiré pattern matching the line or hole grid, e.g. in the shape of lighting-up Moiré icons or similar microimages. Moiré-like magnification and/or movement effects can thus preferably be realized in the finished security document. The linked regions of the two security elements have been or are realized in particular one lying on top of the other here.

Further, it is possible for the first security element 2 and/or the second security element 4 to be designed semi-transparent and/or transparent, in particular to have a transmittance in the wavelength range visible to the human eye selected from the range of from 380 nm to 780 nm, preferably from 430 nm to 690 nm. It can hereby advantageously be achieved that, even in the OFF state or at the predefined second observation angle, a high level of design freedom can be guaranteed the security document 1 for optical effects in the background region 21 and, for example, further items of information or decorations can be shown on the first side behind the first security element 2 or a high-contrast substrate can be provided for the absorption region 30, in particular by means of core, preferably the core layer 55, or layers printed thereon.

The first security element 2 is arranged, in particular over a large area of surface or over the whole surface, behind the absorption layer 52 for the formation of at least one item of personalized information 3, which is preferably a portrait. In front of the absorption layer 52 for the formation of the at least one item of personalized information 3, which is preferably a portrait, a second security element 4 is optionally arranged preferably offset with respect to the absorption region 30, in particular to the absorbent regions of the portrait in the absorption layer 30. Advantageously, a portrait can thus be protected against manipulation attempts on both sides and is in particular easy to check for its authenticity by means of the two security elements and their interplay with the absorption region. For example, by simply tilting the security document 1 forward and backward, the first security element 2 behind the absorption layer 52 can be activated and deactivated, thus brought into the ON state and the OFF state, with the result that in the ON state incident light is diffracted, for example by relief structures of the first security element 2, such that the absorption region 30, in particular the portrait, can be perceived by the observer underneath the first security element 2 dissociated from the substrate and, for example, appears to be located in front of a lightbox, wherein an optionally printed background is outshone by the first security element 2. In this way, the first security element 2 lying behind the absorption layer 30 can, in the ON state, be used to make the targeted inspection of the portrait easier through a stronger accentuation with respect to the background. If the first security element 2 is moved into the OFF state by tilting the security document 1 into a different observation angle, a further document inspection is preferably possible, for example by means of the second security element 4 or further security elements.

A difference in brightness in the second region 22 is thus advantageously stronger at a predefined first observation angle, in particular in the ON state, than at a predefined second observation angle, in particular in the OFF state. The arithmetic mean of measured values of the reflected and scattered light in the first region, measured as a brightness value or grayscale value, is at least 5%, preferably at least 10%, further preferably at least 15%, greater at the predefined first observation angle than at the predefined second observation angle.

In particular, the maximally strongest contrast in the second region 22, preferably between background 21 and absorption region 30, is greater at the predefined first observation angle than the maximally strongest contrast in the second region 22, in particular between background and absorption region 30, at a predefined second observation angle, preferably wherein the reflection is weaker in partial regions of the item of personalized information 3, in particular absorption regions 30, than in the partial regions of the second region in which no absorption regions are present. It is also possible for the first security element 2 to be designed such that an increase in a brightness, in particular in the second region 22, is smaller in the absorption region than in the background region 21 in the case of a change from an observation at the predefined second observation angle to an observation at the predefined first observation angle. It is also possible for the absorption region 30 to have an optical density, at least in the first region, with a maximum optical density of 3, in particular measured according to ISO 13655:2017 (E). It is expedient that the relative difference in brightness of partial regions of the second region 22 outside the absorption region and partial regions in the absorption region 30 lies in a range of from 5% to 99.9% at the predefined first observation angle.

FIG. 1b shows a security document 1 as described in relation to FIG. 1a, except for the difference that the layers 52 and 53 are shown transposed.

FIGS. 1b and 1c show by way of example embodiments with different sequences of material between the first security element 2 and the second security element 4. The important differences between the layers relate in particular to the behavior under the influence of a laser. By the behavior under the influence of a laser is meant in particular the extent of how strongly a blackening, or generally a change in color, takes place. Differently pigmented layers, in particular pigment type and concentration, can react to the energy of a laser with different strengths. The thicknesses of individual layers can be very different, for example between 20 μm and 500 μm, wherein thicknesses in a range of from 30 μm to 150 μm are preferably used for transparent layers.

Transparent layers comprising or consisting of polycarbonate (PC), PVC or PET are preferred in the case of layers 57 and 58 of FIG. 1c.

FIG. 1d shows a security document 1 as described in relation to one of FIGS. 1a to 1c with the difference that the interspace between the first security element 2 and the second security element 4 is formed exclusively by an absorption layer as laserable layer 52. In other words, in this exemplary embodiment, a laserable layer 52 is located in the whole interspace between the first security element 2 and the second security element 4.

The security document 1 shown by way of example in FIG. 1e shows a security document 1 as described in relation to FIG. 1d, wherein the first security element 2 is divided into partial regions. A security document as described in relation to FIG. 1e can look like the security document 1 shown schematically in FIG. 4f at the predefined first observation angle for example. In other words, the first security element 2 is present only partially, in particular in the absorption region 30, and preferably has interruptions and/or cutouts. Through such a division of the first security element 2 into partial regions, bonding bridges can be achieved between the layers, in which the materials of the layers are joined directly to each other, in particular in the region of the interruptions and/or cutouts. In terms of material, the second security element 2 in particular represents a foreign body and can lead to a weakening of the composite. It has been shown that, precisely in the case of larger extents of the second security element 2, problems can arise with the durability of the security document 1 or a possible attack surface can be presented in the case of an attempt by a forger to split the composite, with the result that an improved protection against forgery and improved durability can advantageously be achieved through the interruptions and/or cutouts. In the case of a suitable design, the interruptions can additionally also serve as a design element or further security feature.

It is also conceivable that the first security element 2 has only a partially arranged reflective layer, which is arranged for example corresponding to the regions 20 shown in relation to FIG. 1e or to FIG. 4f.

FIG. 1f shows a security document 1, which is a paper document or a polymer card, for example, with a substrate 7 and an absorption region 30, which is spanned by a printed layer 31. It is thus possible for the absorption layer preferably to comprise a printed layer 31 in place of or in addition to a laserable layer. The substrate 7 is in particular selected individually or in combination from paper, teslin, PVC, ABS, PET and composite. The second security element 2 is applied to a pre-printed substrate 7, such as for example a paper substrate or a polymer card. Optionally, a varnish, which in particular increases the adhesion to a print for the formation of the item of personalized information, is at least partially applied. The printed layer 31 can for example be formed by inkjet printing, laser printer, thermal transfer, D2T2 (=dye diffusion thermal transfer) or retransfer printing or combinations thereof. It is also possible for the applied first security element 2 already to be provided with a receptive layer, which in particular increases the adhesion to the printed layer 31. After the printing of the item of personalized information 3, the application of the second security element 4 is preferably effected, for example over the whole surface or partially. The transparent cover layer 51 is usually formed by an adhesive layer for binding the second security element 4, which is formed in particular as overlay 6. The adhesive layer can be thermally activatable, radiation cured or chemically post-crosslinking. In particular, the security element 4 can be an overlay 6. Such overlays can serve not only to protect against forgery but also to protect the personalization against abrasion or dirtying. Overlays with a layer of PET with thicknesses in the range of 10 μm to 150 μm, preferably in the range of from 10 μm to 50 μm, provide particular protection against abrasion for example.

FIG. 1g shows a security document 1 as described in relation to FIG. 1d and to FIG. 1e, wherein the item of personalized information 3 is distributed onto two layers, which in particular can be blackened or have been or are blackened by means of laser radiation. It is thus possible for a further absorption layer 521 to be arranged behind the first security element 2 when the first side is observed, in particular wherein the at least one item of personalized information 3 is composed of the absorption layer 52 and the further absorption layer 521 when observed at the second observation angle. In this case, the security document 1 has, besides absorption layer 52, the further absorption layer 521, which is arranged underneath the first security element 2 in observation of the first side. The layers 52 and 521 are both laserable in this example. In this embodiment example, one of the layers 52 and 521 is in particular arranged between the first security element 2 and the second security element 4. The extent of the blackening achieved by means of lasers can be different in the two layers 52 and 521 represented. If the optical effect of the first security element 2 does not light up for an observing person, they recognize the item of personalized information composed of both blackenings. Thus, at the first observation angle, in which the second security element 2 in particular serves as backlighting of a blackening in the absorption layer 52, substantially only the effect in the absorption layer 52 is still recognizable.

FIG. 1h shows a security document 1 as described in relation to FIG. 1d and to FIG. 1e, which has a window region 550. In the window region 550, a further item of optical information 32 is realized by the absorption region 30. The recognizability of the further item of optical information 32 in reflected light can hereby be designed to be low because a contrasting, for example “white”, background is lacking. Through the third security element 41, a backlighting of the further item of optical information 32 at a further predefined angle can be achieved and thus in particular the further item of optical information 32 can be easily checked by “switched on and off”.

FIG. 1i shows a security document 1 with a total of four security elements 2, 4, 41 and 42, wherein the first and the second security element 2 and 4 serve to protect the at least one item of personalized information 3 in the form of a primary image and the third and fourth security element 41 and 42 analogously protect the further item of information 31 in the form of a secondary image.

In relation to FIGS. 1a to 1i, in particular in each case only the structures of finished security documents 1 are represented schematically. In the production thereof, different layers are joined together to form a layer composite. One or more security elements out of the first to fourth security elements 2, 4, 41 and 42 can have been or be applied to the top or underside of the same layer, in particular polymer layer, or have been or be applied to different layers, which are then positioned relative to each other during the joining together to form a layer composite. The security document 1 results in particular through lamination and/or gluing of the layer packet.

The layers 51 to 58 and 521 described in relation to FIGS. 1a to 1i preferably comprise or consist of one or a combination of the following materials: polycarbonate (PC), polyvinyl chloride (PVC), polyethylene terephthalate (PET). PC is preferably used for ID cards or passport data pages. Alternative structures can be based for example on PVC or PET, or also be composed of different plastic materials.

FIG. 2a shows a system 10 for producing a security document 1. The system 10 is in particular a label. With the system 10 shown in FIG. 2a, a security document 1 as shown in FIG. 2b is preferably produced, or can be produced with it. The system 10 comprises an auxiliary carrier 105, on which a first partial element 11 of the security document 1 and a second partial element 12 of the security document 1 is arranged. The first partial element 11 can be made to overlay the second partial element 12 by bending the auxiliary carrier 105. The first partial element 11 has the first security element 2 and the second partial element 12 has an adhesive layer 101 and the second security element 4, wherein the adhesive layer 101 is arranged on the side of the second security element 4 facing away from the auxiliary carrier 105. The absorption layer 31, and/or also the absorption layer 52, with the absorption region is arranged or is able to be arranged on the side of the first partial element 11 facing away from the auxiliary carrier 105.

The auxiliary carrier 105 can, for example, consist of or comprise a paper. The first partial element 11 and the second partial element 12, which in each case preferably have a carrier element 103 or 104, respectively, are arranged on the auxiliary carrier 105. The carrier element 103 and the carrier element 104 can, for example, be a polyester ply, in particular comprising or consisting of PET, detachable from the auxiliary carrier 105. The carrier elements 103 and 104 are separated from each other or joined by means of a mechanical weak point. Such a mechanical weak point can include a perforation or a scoring or an indentation. The joining of the two partial elements 11 and 12 together to form a final security document 1 can advantageously be simplified hereby. The carrier element 103 and/or the carrier element 104 can comprise further layers, in particular a replication layer and a partial detachment layer.

On the left-hand side in the embodiment example shown by way of example in FIG. 2a, a second security element 4 is located in the second partial element 12, which second security element is present over the whole surface therein. A second security element 4 present over almost the whole surface, which covers more than 80%, preferably more than 90%, of the surface of the second partial element 12 and/or of the security document 1, preferably of the visible surface when the first side is observed, is also conceivable. Here, by the surface of the second partial element 12 is meant in particular the surface in the case of observation perpendicular to a plane spanned by the second partial element 12, thus for example from top to bottom in FIG. 2a. The second security element 4 in particular comprises a reflective layer in the form of an HRI layer, in particular wherein a relief structure with a diffractive optical effect is molded in the reflective layer. An adhesive layer 101 is additionally arranged on the second partial element 12. The adhesive layer 101 is preferably a so-called PSA (Pressure Sensitive Adhesive), which makes the bonding to the first partial element 11 on the right-hand side possible. The adhesive layer 101 is preferably covered by a protective layer 102, which is detachable or is detached before the two partial elements 11 and 12 are joined, preferably after the at least one item of personalized information 3 has been applied, in particular by printing on the printed layer 31. The protective layer 102 preferably has a siliconization. The protective layer 102 is preferably comprised by the covering or forms the covering.

Alternatively or additionally to the second security element 4, a covering, which is preferably transparent, can also be provided in the left-hand partial element 12. It is also possible for the second security element 4 to be present over only part of the surface and optionally a preferably transparent layer, in particular cover layer, to be arranged on the side facing the auxiliary carrier 105 and/or facing away from the auxiliary carrier 105.

The adhesive layer 101 preferably forms an outermost side of the second partial element 12 or the protective layer 102 forms an outermost side of the second partial element 12 and covers the adhesive layer 101.

The first security element 2 is preferably arranged on the side of the first carrier element 104 facing away from the auxiliary carrier 105. The carrier element 104 of the first partial element 11 can in particular have a printed layer 8. The printed layer 8 is preferably monochromatic. The printed layer 8 can consist of or comprise a white print and in particular comprise further overprints, for example by means of flexographic or offset printing. Alternatively, the printed layer 8 can be a ply made of paper or synthetic paper, in particular teslin. The first security element 2 with the preferred function of “backlighting” the in particular appliable or applied, preferably printed, absorption layer 31 for the formation of the item of personalized information 3, is located on this printed layer. One or more layers which for example increase the adhesion of the absorption layer 31 or increase its resolution can be provided on the side of the security element 2 facing away from the carrier element 104.

The first security element 2 has been or is provided with the absorption layer 31 for the formation of at least one item of personalized information 3 in particular in a printer, for example a toner printer or inkjet printer or thermal transfer printer. The preferably printed absorption layer 31 is represented in FIG. 2a only in the region of the first security element 2. However, further items of information, preferably further items of personalized information, can in particular also have been or be provided, preferably printed, outside the first security element 2.

It is possible for the protective layer 102 to be peeled off, preferably after the absorption layer 31 has been printed. It is further possible to join the two partial elements 11 and 12 together to form a security document 1, in particular to form the security document 1 shown in FIG. 2b. Here, the adhesive layer 101, in particular in the form of a PSA layer, in particular ensures the joining of the two partial elements 11 and 12. Then, the security document 1 produced in this way can be detached from the auxiliary carrier 105. The auxiliary carrier 105 thus advantageously serves for a simplified handling during the production of the security document 1, in particular during the printing of the item of personalized information 3, and as a holder in order to ensure a register-accurate joining of the partial elements 11 and 12 together.

Alternatively or additionally to the printed layer 31, a laserable absorption layer can also be applied to one or more of the layers out of carrier element 104, printed layer 8, security element 2, printed layer 31. The absorption layer preferably comprises or consists of PC or PVC. The absorption layer is in particular laserable and is preferably transparent. The laserable absorption layer can have been or be blackened for example in the absorption region 30 by means of lasers, with the result that the item of personalized information 3 or further items of information have been or are introduced.

FIG. 3a shows, schematically, a detail of a transfer film with a transfer ply, wherein the transfer ply comprises a security element, in particular comprises the first security element 2.

A security element with optically variable effect typically consists of a sequence of layers which fulfill different functions. In the case of a layer structure for transfer plies, as represented in FIG. 3a, the structure consists of a detachment layer 202, a replication layer 203, a reflective layer 204, a stabilizing layer 205 and an adhesive layer 206. Individual layers can also be omitted or on the other hand consist of several partial layers. Before the application to the target substrate, these transfer plies are detachably joined to a carrier 201.

The detachment layer 202 ensures, during the application, that the layer composite of the transfer plies is detachable from the carrier ply 201. When the security element is laminated into a layer composite, as described by way of example in relation to FIG. 6, this layer additionally ensures that a good adhesion to the adjacent layer, in particular polycarbonate ply, is achieved. The separation from the carrier 201 can additionally be improved through one or more thin wax layers. The thickness of this detachment layer 202 preferably lies in the range of from 0.2 to 10 μm, preferably in the range of 0.2 to 5 μm. The thickness of the optionally present wax layers lies in particular in the range of 1 nm to 50 nm.

The preferably optically active structures, which cause the optically variable effect, are molded into the replication layer 203 as a relief. The molding can be effected thermoplastically by structuring the surface under pressure and temperature by means of a tool which has the optically active structures as an in particular negative relief. Alternatively, it can be a polymerizable varnish, consisting of monomers and oligomers, which is polymerized after or during the introduction of the relief. This polymerization can be effected by means of UV radiation or electron beam radiation. The thickness of this replication layer 203 preferably lies in the range of from 0.2 μm to 20 μm, preferably in the range of 0.2 μm to 10 μm. The replication layer can also represent a hybrid form, because it is thermoplastically deformable and then has been or is cured.

A further layer, which fulfills further functions, can be located between detachment layer 202 and replication layer 203. This includes, for example, a stabilizing mechanical action against degradation during the laminating, in particular during the laminating of the first security element 2 in polycarbonate. For this, such a layer is preferably thermally stabilized, for example by crosslinking by means of radiation or a chemical reaction.

The reflective layer 204 consists of a material with a high refractive index, which is preferably vapor-deposited or sputtered-deposited in vacuum. The refractive index in the visible range, in particular for wavelengths of from 420 nm to 780 nm, is advantageously higher than 1.9. The layer thickness lies of the layer 204 lies in particular in the range of 40 nm to 200 nm, preferably in the range of 40 nm to 100 nm. Typical materials are ZnS or TiO₂. This layer can also be designed to be only partial or to have different thicknesses in partial regions.

A stabilizing layer 205 can optionally be applied. It serves to ensure the brilliance of the optical effects during the lamination and to avoid warping of the transfer plies. Such a stabilizing layer 205 can be formed by a varnish crosslinkable by means of radiation or also by a chemically reactive varnish, such as for example an epoxy resin. Thicknesses of the optional stabilizing layer lie in the range of from 0.5 μm to 20 μm, preferably in the range of 1.0 μm to 10.0 μm. The stabilizing layer 205 can also consist of several plies and for example include an adhesion-promoter layer, not represented, for binding to the reflective layer 204.

The adhesive layer 206 serves to bind the transfer plies to the substrate during the application. This can be an adhesive layer 206 which is activated by means of heat and pressure. In particular, a heated stamp is used, the shape of which determines the region to be transferred. The transferred region in particular forms the security element.

Alternatively, a transfer can be effected by means of a so-called cold transfer. Here, an adhesive is printed, substrate and transfer plies are brought into contact and the adhesive is cured in particular by means of UV radiation. The transferred region is determined by the printing of the adhesive. The adhesive layer 206 can in turn be made up of several different layers and, for example, include an adhesion promoter in order to ensure the binding of the adhesive layer 206 to the reflective layer 204 or to the possibly present stabilizing layer 205.

The adhesive layer preferably has a layer thickness in the range of from 0.2 μm to 20 μm, preferably 0.2 μm to 10 μm.

As an alternative to the transfer of transfer plies, the carrier 201 can also be transferred. In the process, the above-described transfer plies are bound to the carrier 201, with the result that an adhesion-promoter layer is present in place of the detachment layer 202. Thermally stable carriers 201, for example made of polyester, can ensure that the optical effects only degrade a little during the laminating. It is preferred here that the carrier 201 is designed in the desired shape before or during the application, for example by means of punching or laser cutting. Depending on the carrier 201 used, a further adhesion promoter can additionally be needed on the rear side in order to ensure a good binding to the layer, located above it, of the security document, in particular a polycarbonate ply. The thicknesses of the carriers 201, which are preferably transferred as part of the security element, lie in the range of 5 μm to 50 μm, preferably in the range of from 10 μm to 35 μm.

Thus, it is possible in particular for a security element transferred by means of the transfer plies to have the following properties.

Possible optically variable security elements which can be provided in front of the at least one item of personalized information when the first side is observed are film elements with, for example, transparent or also partially metallized security elements or other microstructure-based elements or multi-layered structures made of alternating high- and low-refractive-index materials. Further possibilities are micro- and/or macrostructures which are present on the surface of the security document. Possible optically variable security elements which can be provided behind the at least one item of personalized information when it is observed are likewise film elements with, for example, diffractive security elements or other microstructure-based elements or multi-layered structures made of alternating high- and low-refractive-index materials. Behind the at least one item of personalized information, the optically variable security element may possibly also be opaque, in other words non-transparent.

It is possible for the first security element 2 and/or the second security element 4 to be designed semi-transparent and/or transparent, in particular in the wavelength range visible to the human eye selected from the range of from 380 nm to 780 nm, preferably from 430 nm to 690 nm. It is also possible for the second security element to be designed opaque, in particular to have a transmittance selected from the range of from 0.1% to 30%, preferably from 1% to 10%, in the wavelength range visible to the human eye. It is also possible for the first security element 2 and/or the second security element 4 to have a carrier, in particular made of PET or PEN, wherein the carrier preferably has a layer thickness selected from the range of from 5 μm to 150 μm, further preferably from 5 μm to 50 μm, still further preferably from 10 μm to 25 μm. It is also possible for the first security element 2 and/or the second security element 4 to have at least one replication layer, in particular wherein the at least one replication layer has a layer thickness selected from the range of from 0.2 μm to 20 μm, preferably from 0.2 μm to 10 μm. The first security element 2 and/or the second security element 4 expediently has at least one reflective layer with a preferred layer thickness selected from the range of from 40 nm to 200 nm, further preferably from nm to 100 nm, wherein the reflective layer is formed in particular of ZnS or TiO₂ and/or wherein the reflective layer preferably has a refractive index of more than 1.9 in the wavelength range visible to the human eye, preferably of from 430 nm to 780 nm. It is also possible for the reflective layer to be arranged over part of the surface or over the whole surface in the security document 1, in particular wherein the reflective layer has different layer thicknesses at least over part of the surface. It is also possible for the first security element 2 and/or the second security element 4 to have at least one stabilizing layer with a preferred layer thickness selected from the range of from 0.5 μm to 20 μm, further preferably from 1.0 μm to 10 μm, wherein the stabilizing layer is single-layered or multi-layered and preferably comprises an adhesion-promoter layer. It is also possible for the first security element 2 and/or the second security element 4 to have at least one adhesive layer with a preferred layer thickness selected from the range of from 0.2 μm to 20 μm, further preferably 0.2 μm to 10 μm, in particular wherein the adhesive layer is formed of hot-melt adhesive or cold glue, and wherein the adhesive layer is designed single-layered or multi-layered. It is also possible for the first security element 2 and/or the second security element 4, in particular in the reflective layer and/or the replication layer, to have at least one relief structure, wherein the at least one relief structure deflects, in particular diffracts and/or reflects, the incident light in predetermined angle ranges. It is preferred that the at least one relief structure is a blazed structure, in particular with a grating period of more than 3 μm, further preferably more than 5 μm, and in particular at most 25 μm.

FIG. 3b shows, schematically, an example of a cross section of a security element, in particular in the security document, with an achromatic effect. The first security element 2 preferably has relief structures, which in particular show substantially no pronounced diffractive colors and deflect, in particular diffract or reflect, the incident light into predetermined angle ranges in particular with high efficiency.

FIG. 3b preferably shows the first security element 2. The security element 2 has at least one of the layers stabilizing layer 205 and adhesive layer 206, as are described in particular also in relation to FIG. 3a. The reflective layer 204, which follows the relief structure of the replication layer 203, is arranged adjoining it. The relief structures are in particular blazed structures. Still further layers, for example as in relation to the transfer ply described in relation to FIG. 3a, e.g. the detachment layer 202, can also be arranged on top of the replication layer 203 or on the side of the replication layer 204 facing away from the reflective layer 204. The security element 2 can additionally comprise the transparent layer 51 or have been or be joined to this layer.

Compared with the wavelength of visible light, preferably with wavelengths in a range of from 430 nm to 690 nm, achromatic blazed structures have a large grating period, preferably a grating period of more than 3 μm, in particular more than 5 μm. Their effect can be explained approximately by means of geometric optics. An example of such a structure is represented in FIG. 3b. Incident light at an angle of incidence @ relative to the normal of the security document or of the security element penetrates through the layer 51, which here for example consists of or comprises polycarbonate, and is partially diffracted or reflected by the blazed structure and can be observed at the angle β relative to the normal. The angle β is determined, besides the angle of incidence @, by the inclination a of the facets of the blazed structure, as well as the refractive index of the layer lying on top of the structure, in particular the replication layer 203 in FIG. 3b.

For light which is incident perpendicularly and a refractive index of the replication layer of n=1.5, sin (β)=n*sin (2*α) results, or, in the case of small angles α, roughly β=3*α. In the case of small angles, the sine can be approximated well by the arc measure of the angle. Specifically, in the case of α<10° the maximum error is <4.5%, in the case of α<7° the maximum error is <2.2%. In the case of periods where d>3 μm, the incident light is deflected in such a way that color splitting by the grating structure is reduced for an observer, with the result that in particular an achromatic effect is referred to. In addition, the deflection is effected very effectively, with the result that the majority of the reflected light is concentrated in a narrow angle range of a few degrees. Thus, more than 65% of the reflected light can be concentrated around the angle β+/−5°. In the case of transparent HRI layers, such as for example ZnS or TiO₂, the quantity of the reflected light and the spectrum thereof is dependent on the refractive index of the HRI layer, the refractive indices of the two adjacent layers, as well as on the layer thickness of the HRI layer. Assuming that the HRI layer is ZnS with a typical refractive index of 2.35, in particular disregarding the wavelength dependence, and in each case n=1.45 for the adjacent layers, there is a maximum reflection of approx. 20%. This means that correspondingly approx. 80% of the incident light is allowed to pass through, if any possible absorption is disregarded. The three observation ranges can thus be achieved, in particular the predefined first observation angle, the predefined second observation angle and/or the predefined third observation angle.

It is advantageously possible for the first security element 2 to have substantially achromatic optically variable effects at least in partial regions, preferably in the second region. These have the advantage that they increase the recognizability in relation to the absorbing, often black-absorbing, at least one item of personalized information 3, at least at the predefined first observation angle, due to the backlighting and behave color-neutrally, unlike colored optically variable effects. This is advantageous in particular when overlapping portraits, since color effects are, if anything, perceived by the observer as disrupting or confusing there, with the result that here a particularly simple checking by an observer can be made possible. In particular the structures described in relation to FIG. 3b are suitable for the formation of an achromatic optically variable effect or of the first security element, which is achromatic at the predefined first observation angle or provides a backlighting of the at least one item of personalized information 3.

Alternatively or additionally, it is possible for the first and/or the second security element preferably to comprise a diffractive grating. Such a diffractive grating is preferably selected individually or in combination from: linear grating, crossed grating. The diffractive grating preferably has a grating period in a range of from 200 nm to 10 μm. The diffractive grating in particular has a grating depth in a range of from 50 nm to 2 μm, preferably between 80 nm and 1.5 μm. A diffractive grating with grating periods of less than 500 nm and preferably less than 400 nm is further conceivable. These are subwavelength gratings which have color impressions and/or color effects in the zero diffraction order, thus in particular in direct reflection, when these gratings are provided with a high-refractive-index layer or with a metallic layer. If the gratings are provided with a high-refractive-index layer, in particular the so-called RICS color effect forms. If the gratings are provided with a metallic layer, e.g. aluminum, then in particular plasmonic color effects form. The absorption region advantageously contrasts well with the color impression of a diffractive grating, as a result of which the items of personalized information can be checked better by the observer than the personalizations previously known in the state of the art without a security element lying behind them.

FIGS. 4a and 4b show, schematically, an example of a preferred embodiment of a security document 1 at different defined observation angles. FIG. 4b shows the observation at the predefined first observation angle, in particular in the ON state. FIG. 4a shows the observation at the predefined second observation angle, in particular in the OFF state. The security document 1 can in particular have the structure described in relation to FIG. 1a.

FIG. 4a and FIG. 4b show optional further items of personalized information 32, in particular compared with FIG. 1a and FIG. 1b. These can, for example, likewise be introduced into the absorption layer 52 by blackening by means of a laser.

An example of a determination of the brightness values, in particular as grayscale values, by means of a camera is described below.

The median value, mean value and the standard deviation were determined from several measurements at different points. The median value is the so-called median, thus the central value in a series of measurements. In the case of five measured values, this would be the third value for example and in the case of four measured values it would be the mean value of the second and third values when the measured values are sorted from the small result to the large result. The mean value is the so-called arithmetic mean, thus the averaged value of a series of measurements, for example in the case of five measured values the sum of the five measured values divided by five. The standard deviation denotes the scatter range of a series of measurements. These values for a portrait in the ON state, as is described for example in relation to FIG. 4b, are summarized in a table below.

| | | Median | Mean value/ | |
|---|---|---|---|---|
| | Motif region/ | value/ | Arithmetic | Standard |
| Position | Measurement region | Median | mean | deviation |
| 1st | bright forehead | 148 | 150.4 | 21.2 |
| 2nd | dark hair | 29 | 34.4 | 23.5 |
| 3rd | background region 21 | 177 | 180.6 | 25.4 |
| 4th | substrate | 102 | 100.0 | 6.8 |

The available value range in the case of a preferred digital 8-bit coding is in particular brightness values between 0 (totally dark) and 255 (maximum brightness value). There are thus 256 different grayscales, i.e. black (value 0) and white (value 255) and 254 gray tones in between.

The background of the template can have a light print underneath the first security element 2. Because of the diffuse scattering of the core layer 55 that is designed white here, the substrate or the region which is arranged both outside the absorption region 30 and outside the first region 20 appears relatively homogeneous in the case of brightness values, i.e. grayscale values, of around approximately 100 with a slight variation of the brightness distribution, as can be learned from the row of the 4th position. In the example of FIG. 4a and FIG. 4b, the substrate could be measured in particular for example in a region between the first security element 2 and the lettering “IDENTITY CARD”. In a region with a lighting-up first security element 2, thus in the background region 21, there are much higher brightness values of around 180, as can be learned from the row of the 3rd position. The distribution of the brightness values can additionally be broadened because of slight warping of the second security document, which can form when the security document 1 is laminated. The variations can also be introduced in a targeted manner and already be introduced during the production of the first security element 2, for example in order to enlarge the angle range of the predefined first observation angle, at which the background region 21 lights up. The region of the forehead has only a slight blackening of the absorption layer 52, for example, with the result that the measured brightness value is in the region of 150, whereas in the region of the dark hair the values are around 30.

The variation of the detected brightnesses is not only due to the variation of the brightness of the first security element 2 but is also determined by the type of absorption layer and the introduced absorption regions. It is additionally to be borne in mind that the scattering can also be caused by a high resolution of the image acquisition. A lower resolution leads to an averaging and thus to a reduction of the scattering. In this way, it can in particular be ascertained how predefined observation angles can be achieved at which the at least one item of personalized information 3, in particular the portrait, has a preferably defined, viewing-angle-dependent contrast and/or difference in brightness.

In the OFF state, which is illustrated by way of example by FIG. 4a, the following values were ascertained in this example:

| | | Median | Mean value/ | |
|---|---|---|---|---|
| | Motif region/ | value/ | Arithmetic | Standard |
| Position | Measurement region | Median | mean | deviation |
| 1st | bright forehead | 100 | 99.6 | 4.68 |
| 2nd | dark hair | 8 | 8.6 | 5.96 |
| 3rd | background region 21 | 90 | 90.05 | 4.79 |
| 4th | substrate | 82 | 81.08 | 4.38 |

In the following, example calculations of the brightness contrast, in particular between absorption region, preferably partial regions of the absorption region, and the background region and an optical density calculated therefrom are described.

### ON State

bright forehead:

$$contrast = 150.4 / 180.6 = 0 \text{.83}$$

$$optical density = log ( 0. 83 ) * ( - 1 ) = 0.08 .$$

dark hair:

$$contrast = 34.4 / 180.6 = 0.19$$

$$optical density = log ( 0. 19 ) * ( - 1 ) = 0.72 .$$

### OFF State

bright forehead:

$$contrast = 99.6 / 90.05 = 1 \text{.11}$$

$$calculated optical density = log ( 0. 83 ) * ( - 1 ) = - 0.04 .$$

The thus-calculated optical density in the region of the bright forehead can result in particular when, for example, there is a print in the background (position 3) while the forehead region does not include a print but has a white substrate.

dark hair:

$$contrast = 8.6 / 90.05 = 0 \text{.096}$$

$$calculated optical density = log ( 0. 0 \; 96 ) * ( - 1 ) = 1.02 .$$

Between dark hair and background region 21 a value of 1.00 results for delta OFF and a value of 1.45 results for delta ON. A value for D of 31% follows from this.

In the OFF state, in particular the contrast and the optical density determined therefrom can be more pronounced at least in partial regions, preferably when a blackening is also present underneath the first security element. In the OFF state this blackening acts in particular additively with that on top of the first security element, whereas in the ON state primarily the blackening on top of the first security element acts.

At the first observation angle, the difference in brightness, i.e. in particular delta ON, preferably has a maximum value in the second region 22 between absorption region and background region 21 which is greater than 10%, preferably is greater than 15%.

The minimum value of the standardized difference D is in particular 5%, preferably 10%, preferably 15%, in particular wherein the minimum value applies to a region with the largest standardized difference D.

The first security element located behind the item of personalized information 3, in particular the portrait, when the first side is observed is preferably implemented with an achromatic ON/OFF effect. Under most observation arrangements between incident light, structures of the first security element and observer or receiver, the first security element 2 is not conspicuously visible. It is then inactive or in the OFF state, as represented in FIG. 4a. Only at a predefined first observation angle, which can in particular also be an angle range, which prevails between incident light, structures of the first security element and observer or receiver does the first security element 2 light up over the whole surface, as represented by way of example in FIG. 4b. It is then active or in the ON state. The perception is reminiscent in particular of a lightbox which is switched on/off behind the personalization. In this way, the contrast with respect to the item of personalized information, in particular the portrait, can be strengthened in a targeted manner, which in turn results in easier checking of the item of information designed, for example, as a primary image. A preferred primary image in the OFF state and in the ON state of the security element 2 are additionally preferably visible in perfect register with each other, with the result that forgeries stand out more easily.

In a preferred embodiment, the first security element 2 is achromatic in the second region 22 when observed at the predefined first observation angle. Particularly suitable structures for the first security element 2, in particular as a lightbox, are so-called blazed structures, as are represented schematically in cross section in FIG. 3b. The first security element 2 preferably has blazed structures with an angle range for the inclination a in the range of from 0 to 40 degrees, preferably in the range of from 3 to 30 degrees, further preferably in the range of 5 to 25 degrees. In the case of periodic structures, such as for example a blazed structure, the periods d have values greater than 3 μm, preferably greater than 5 μm. The structure depth h results from the angle α and the period d as: h=d*sin (α).

The refractive index of the layer adjacent to the reflective layer 204 and pointing toward the observer, for example the replication layer 203, or in the inverted application the layer 205, preferably has a refractive index in a range between 1.35 and 1.65, preferably in the range between 1.4 and 1.6.

The reflective layer 204 preferably consists of a dielectric material with a high refractive index. The refractive index differs from the adjacent layers by at least 0.3 and is above 1.9, preferably above 2.05. Popular materials are, for example, ZnS or TiO₂, which are applied in a layer thickness in the range of from 40 nm to 250 nm, preferably in the range of from 50 nm to 200 nm, particularly preferably in the range of 50 nm to 100 nm.

Through a suitable choice of the layer thickness of the reflective layer 204 as HRI layer, a color impression of the first security element 2, in particular of the lightbox, can be achieved. A layer thickness of the HRI layer in a range of from 40 nm to 280 nm, further preferably of from 40 nm to 100 nm, is in particular preferred. In the case of layer thicknesses in the range of from 70 nm to 100 nm, the first security element 2, in particular the lightbox, can appear golden or copper-colored for example in direct reflection in the ON state. For example, in direct reflection in the ON state the first security element 2, in particular the lightbox, appears yellow in the case of a layer thickness of 90 nm, blue in the case of a layer thickness of 140 nm, red in the case of a layer thickness of 200 nm, green in the case of a layer thickness of 280 nm. Such colorings can be disruptive in specific embodiments since at the same time the diffraction efficiency that is integrated over the whole visual spectral range is reduced and the first security element or the lightbox can light up less brightly. Preferred embodiments with layer thicknesses below 100 nm can therefore be particularly advantageous.

Furthermore, the first security element 2, in particular as a lightbox, can have a metallic reflective layer in partial regions. This partial region is preferably located in regions which are not personalized or are only slightly personalized by means of lasers since the laser personalization can lead to damage to the metal layer. This additional metallic effect can be utilized as a further feature that is easy to check. The presence of the lightbox can additionally be indicated by a slight coloring of the layers of the first security element 2. Here, colors can be present both on top of and underneath the reflective layer, wherein only those on top of the reflective layer would be active in the case of an active lightbox. It is thus conceivable that, to color the second region 22, one or more additional color layers and/or a coloring in a layer in the second region 22 is preferably provided on top of and/or underneath the reflective layer, e.g. in the replication layer and/or in the detachment layer.

At least in a first partial region of the absorption region 30, which forms a grayscale image or a multicolored image, in particular for the formation of a portrait, the first security element 2 is thus achromatic when observed at the predefined first observation angle. The first security element 2 forms only a partial region of the first side of the security element 2, as a result of which in particular a lightbox is visible. It is particularly preferred that the first security element 2 is arranged partially overlapping or overlapping part of the surface of at least one first partial region of the absorption region 30, which forms a grayscale image or a multicolored image, in particular a portrait, in a closed and coherent region with a minimum width or minimum length of 80%, preferably 100%, of the region provided for the first partial region of the absorption region 30.

The region provided for the first partial region of the absorption region 30 is preferably a region of the security document 1 defined for a portrait.

The second region 22, which is formed at least by a partial region of the absorption region 30 and a partial region of the background region 21 directly adjoining it, preferably has the outline of a portrait or of a frame around a portrait. The maximum width and/or the maximum length of the closed and coherent region is preferably 110% of the region, provided for a portrait, of this partial region of the absorption region 30.

It is also possible for the first security element 2 to be colored in a fourth region, wherein the fourth region overlaps, in particular in regions, a second partial region of the absorption region 30, which is preferably formed of alphanumeric characters.

The at least one item of personalized information 3 is preferably formed by means of manipulation of the absorption layer 52 with a laser, in particular through a blackening, and/or through a printed layer 31 comprised or formed by the absorption layer. By background region 21 is preferably meant a partial region of the first region in which no printing or no manipulation by means of lasers is arranged.

The first security element 2 as described in relation to FIG. 4a and FIG. 4b, which preferably lights up homogeneously, can furthermore have further relief structures or mirror surfaces in element regions, as is shown by way of example in FIG. 4c by means of an enlargement, which there show the lettering “KINEGRAM” by way of example. For example, a diffraction grating with a period of 1 μm and a grating orientation of 90° can be present in the element regions, as a result of which the colored diffraction effect of these element regions is recognizable only when the security document 1 is observed turned through 90°. As a result, this effect does not disrupt the achromatic ON/OFF effect of the first security element in the case of normal observation, at the same time the lettering “KINEGRAM” can be checked more easily, in particular in comparison with the case when mirror surfaces are provided.

In particular, it is possible for a first security element 2 lighting up homogeneously at the predefined first observation angle or in the ON state to be or to have been extended by mini-, micro- and/or nanoelements or other preferably achromatically optically variable effects. With these, it is possible in particular to create details which only become conspicuously visible when the first security element is activated or can only be checked under optical magnification, for example by means of a magnifying glass or microscope. It is thus possible to increase the protection against forgery.

It is thus possible in particular for the first security element 2 to have element regions with dimensions below the resolving power of the human eye, wherein relief structures which differ from the relief structures of the surrounding regions of the first region and in particular are motif-shaped are provided in the element regions. The maximum width of the element regions preferably lies in a range of from 2 μm to 250 μm. The surface coverage of these elements is preferably less than 25%.

However, as represented in FIG. 4d, instead of lighting up homogeneously in the ON state, the first security element 2 can also be implemented such that an achromatic brightly lighting up movement effect, which runs through, like a type of scan for example, behind the item of personalized information 3, in particular as a portrait, is generated via a defined tilting movement. The item of personalized information 3, in particular as a portrait, then becomes optically variably recognizable in stronger brightness exactly where the bar of light currently lights up. It is thus possible for the first security element 2 to generate a preferably achromatic movement effect in the second region 22. For example, blazed structures or micromirrors with a varying azimuthal angle, in other words varying orientation, are used for this, or the period of the blazed structure or the flank angle of the micromirrors is varied.

FIG. 4e shows by way of example a security document 1 as described in relation to FIG. 4a and FIG. 4b, wherein the first security element 2 can also be designed such that in the ON state an additional item of information becomes visible through the use of a point light source. The additional item of information is depicted in FIG. 4e by the lettering “OK” and can be provided by corresponding relief structures in the first security element 2. For example, for this the first security element 2 can be formed by means of a computer-generated hologram (CGH).

FIG. 4f shows a further possibility of the design of the first security element 2, in particular of a security document 1 as described in relation to FIG. 1e. Here, the security element 2 overlaps the absorption region 30 in particular only partially or has a reflective layer only partially overlapping the absorption region 30. The first security element 2 is thus preferably formed with real and/or optical interruptions. By interruptions is meant in particular cutouts. The interruptions can have been or be generated by one or more of the following cutouts:

Real cutouts of the first security element 2, in particular of the first region. In particular, the first region can be motif-shaped and for example have a complex shaping. These cutouts additionally serve to form bonding bridges and thus to meet interlayer adhesion (peel) requirements.

Optical cutouts through the use of preferably less conspicuous structures, such as for example isotropic, matte-scattering structures, preferably random structures, e.g. in a nanotext or in the element regions.

Optical cutouts through the use of a partially arranged reflective layer, in particular a partially arranged HRI layer. Here, in particular only a part of the replication layer is thus occupied by the HRI layer and thus visible at all in the first security element.

A special shaping advantageously additionally makes it more difficult to create forgeries and at the same time serve as a design possibility.

It is also possible to implement the first security element 2 such that, in addition to the backing of the at least one item of personalized information 3 by the first security element 2 in the first region 20 and/or the second region 22, further regions of the item of personalized information, such as in particular the further item of personalized information 32, are backed by the first security element 2 or further security elements, in particular are arranged behind the item of personalized information when the first side of the security document 1 is observed.

As FIG. 4g and FIG. 4h show by way of example, it is possible for the security document 1 to have further items of personalized information 32, when the first side of the security document 1 is observed, behind which the first security element 2 has further regions or behind which further security elements are arranged, which in particular are visible at the predefined first observation angle. FIG. 4g and FIG. 4h show the further security elements or further regions by way of example in the shape of a star and a flag.

In particular, this is a multipatch implementation. It is possible here for several so-called patches 300 to back the items of personalized information 3, 32 at different points when the first side is observed. A large-area protection against a forgery attempt from the rear side is hereby achieved.

It is possible to apply the separate regions of the first security element 2 or the first security element 2 and the further security elements individually in each case as a patch 300. The patches 300 can here be arranged in different planes of the security document 1, in particular in each case by application to one of the layers 53 to 58. The patches 300 can thus be located in different planes underneath the personalization and are applied individually in the multipatch implementation and therefore also with tolerances, in particular register tolerances, with respect to each other.

Further, an implementation as FDP (Full Data Protection) is possible. In contrast to the multipatch variant, the different design regions are located in the same plane and in perfect register with each other. Here, several patches 300 have been or are applied to the same layer, in particular to at least one of the layers 53 to 58, preferably to the same layer as the first security element 2. Within the same plane, further parts of the item of personalized information can thus be protected against a forgery attempt from the rear side with improved protection against forgery.

It is thus conceivable in particular, as is represented in FIG. 4g and FIG. 4h, to integrate further effects where they do not disturb, for example color effects based on high-frequency linear gratings and/or high-frequency crossed gratings or 3D effects based on Fresnel lens structures.

As FIG. 4i and FIG. 4j show by way of example, it is possible for the first security element 2 to be present over the whole surface in the security document 1. It is preferred here, as can be seen in FIG. 4j, to see a preferably homogeneous achromatic effect, which is visible in particular over the whole surface on the first side, when the first side of the security document 1 is observed at the predefined first observation angle. The advantages of the invention can thus be expanded in particular also to the whole card surface. Implemented as a purely achromatic surface, in the OFF state the first security element 2 does not stand out at all, as can be seen in FIG. 4i. Advantageously, the inspection of further security elements, such as in particular the second security element 4, is thus possible without being impaired by the first security element 2. If the first security element 2 is moved into the ON state, the lightbox effect can then be perceived over the whole card. The achromatic effect causes layers and security elements lying above the first security element 2 to be outshone and thus switched off for the observer, with the result that the mostly black laser personalization can be perceived as a single layer and the checking thereof can take place much more easily, dissociated from other security features and design elements.

FIG. 5a to FIG. 5d show examples of a security document 1, which in particular is a data page of a passport booklet, preferably a paper data page of a passport booklet. Such a security document 1 is also described in relation to FIG. 1f for example.

The paper data page can comprise a printed layer, preferably including a security print. The at least one item of personalized information 3 is applied to a substrate 7, in particular the data page of a blank document, by means of a digital printing process, for example inkjet printing, and then protected by the application of a preferably whole-surface transparent second security element. The second security element 4 is in particular a transparent, optically variable layer, preferably a so-called TKO (Transparent KINEGRAM Overlay) or KINEGRAM®TKO, which in particular includes a design based on relief structures and preferably comprises a whole-surface HRI layer, with the result that a motif-shaped optically variable effect is formed, which is shown in particular in FIG. 5 by way of example by the sun and the cacti. An optically variable layer is in particular a layer with an optically variable effect.

The security document 1 shown in FIG. 5a has in particular a transparent first security element 2, preferably as a patch, and optionally an overprintable layer, preferably as a patch. The overprintable layer is preferably an adhesion-promoter layer, which has been or was comprised in the transfer ply of the first security element 2, or is printed in particular over the applied patch. The first security element 2 and the optional adhesion-promoter layer preferably have been or are applied to the substrate 7, in particular the prefabricated paper data page, in at least one application procedure. After that, the introduction or attachment of the at least one item of personalized information 3 is effected, and then the application of the second security element 4. In this way it is made possible to print over the at least one item of personalized information 3, in particular the second region 22, and to embed the item of personalized information 3 in the second region at least partially between two security elements, with the result that it is advantageously particularly well protected against forgery attempts. As is illustrated by way of example by FIG. 5a, it is possible for the optically variable effect of the second security element 4 to be visible in the OFF state or at the second predefined observation angle, wherein the at least one item of personalized information 3 can further preferably be visible through the optically variable effect and/or the security element 4 is semi-transparent or transparent.

As is shown by way of example by FIG. 5b, it is possible for both the optically variable effect of the first security element 2 and that of the second security element 4 to be visible in the ON state or at the first predefined observation angle. It is possible here in particular for the first security element 2, in the ON state, to outshine layers lying above it, thus layers lying in front of the first security element 2 in the case of observation from the first side, preferably except for the absorption layer 3 in the absorption region 30, and thus also to outshine the second optically variable security element 4 lying above it. In particular, the visibility of the second security element 4 is reduced by the first security element 2, in particular in a part of the second security element 4 overlapping the first security element 2, preferably the background region 21. In this way, the contrast of background region 21 and absorption region 30 for example can be strengthened in a targeted manner, which in turn results in easier checking of the at least one item of personalized information 3, in particular a portrait. The at least one item of optical information 3 and the first security element 2 are additionally visible in perfect register with each other. At the same time, in particular a part of the second security element 4 that is not overlapping the first security element 2 or the first region 20 is visible, in particular clearly visible, in the ON state, with the result that forgeries advantageously stand out more easily.

FIG. 5c shows in particular a security document 1 as described in relation to FIG. 5b and FIG. 5a. As FIG. 5c shows by way of example it is possible for the security document 1 to have further items of personalized information 32, when the first side of the security document 1 is observed, behind which the first security element 2 has further regions or behind which further security elements are arranged, which in particular are visible at the predefined first observation angle. FIG. 5c shows the further security elements or further regions of the first security element 2 by way of example in the shape of a star and a flag. The further regions of the first security element 2 or the further security elements are preferably arranged overlapping and behind the further items of personalized information 32 at least in regions when the first side is observed. In particular, this is a multipatch implementation. It is possible here for several so-called patches 300 to back the items of personalized information 3, 32 at different points when the first side is observed. A large-area protection against a forgery attempt from the rear side is hereby achieved. It is possible to apply the separate regions of the first security element 2 or the first security element 2 and the further security elements individually in each case as a patch 300. The patches 300 can here be arranged in different planes of the security document 1, in particular in each case by application to substrate or to a cover layer or to a whole-surface second security element 4. The patches 300 can thus be located in different planes underneath the personalization and are applied individually in the multipatch implementation and therefore also with tolerances, in particular register tolerances, with respect to each other.

Further, an implementation as FDP (Full Data Protection) is possible. In contrast to the multipatch variant, the different design regions, as can be by way of example in FIG. 5c several elements out of rectangular first region 20, star and flag, are located in the same plane and in perfect register with each other. Here, several patches 300 have been or are applied to the same layer, in particular to the substrate 7, or one of the layers 52 to 56, preferably to the same layer as the first security element 2. Within the same plane further parts of the item of personalized information can thus be protected against a forgery attempt from the rear side with improved protection against forgery.

Further regions of the first security element 2 provided by the patches 300 or further security elements preferably have a colored and/or diffractive effect.

FIG. 5d shows by way of example a security document 1 as described in particular in relation to FIG. 5b, wherein the first security element 2 is present over the whole surface in the security document 1. Here, the optically variable effect of the second security element 4 that is preferably visible in the ON state is outshone by the first security element 2 and thus in particular its visibility is weakened.

FIG. 5e and FIG. 5f show a security document 1, which is in particular a plastic card. A prefabricated plastic card blank used for producing the security document 1 preferably already comprises a printed layer, which can contain a security print. The at least one item of personalized information 3 is then applied to the prefabricated plastic card blank by means of a digital printing process, for example thermal transfer printing or direct thermal printing. Then, the item of personalized information 3 is protected by application of a preferably whole-surface second security element 4, in particular a KINEGRAM®TKO (Transparent Kinegram Overlay) or KINEGRAM®GUARD. A KINEGRAM®GUARD preferably comprises a polyester carrier, wherein the polyester carrier in particular serves as protective layer, further preferably to protect against abrasion, and an HRI layer, which preferably generates or provides an optically variable effect.

The plastic card shown by way of example in FIG. 5e contains the first security element 2, which is transparent. The first security element 2 is preferably already contained by the prefabricated plastic card blank or applied to it before an absorption layer is at least partially applied to, in particular printed on, the first security element 2. Next, in particular the introduction of the item of personalized information 3 is effected, preferably by means of lasers. Thereafter, the transparent second security element 4 is preferably applied to the security document over the whole surface, for example by means of lamination.

FIG. 5e shows in particular the observation at the predefined second observation angle or the OFF state, wherein the optically variable effect of the second security element 4, shown by way of example by means of the sun and cacti, is visible in this state.

FIG. 5f shows the ON state of the security document 1 shown in FIG. 5e. The first security element 2 outshines layers lying above it, preferably except for the absorption layer 3 in the absorption region 30, and thus also the second security element 4 lying above it, in particular in regions of the first region 20, at least in regions, which are represented by means of the sun here. The optical effects of the second security element 4, represented here by way of example by means of the cacti, are visible in regions outside the first region 20. As already described, the protection against forgery can thus be increased in particular.

It is possible for a security document 1 described in relation to FIGS. 5a to 5f to comprise a first security element 2, as is described in relation to one of the other figures. It is also possible for a security document 1 described in relation to FIGS. 5a to 5f to comprise interruptions, as is described in particular in relation to FIG. 4f.

The optical effects of the second security element 4, depicted in the figures by way of example by means of the sun and the cacti, can in particular be semi-transparent or transparent, with the result that the at least one item of personalized information 3 is not completely hidden when the optical effect of the second security element 4 is visible and/or is not visible.

FIG. 6 shows a method for producing a security document 1, in particular as described in relation to one of the previous figures.

In a method for producing a security document 1, preferably using a system 10 according to the invention, wherein the security document 1 comprises a first side and a second side lying opposite the first side, the following steps are carried out, in particular in the specified order:
providing 201 at least one absorption layer 52 or one absorption layer 31 with an absorption region 30 for the formation of at least one item of personalized information 3, wherein the security document 1 has been processed and/or can be processed in the absorption region 30 such that the at least one item of personalized information 3 is visible, in particular visible to the human eye, through absorption of light incident on the first side;
providing 202 a first security element 2 with an optically variable effect;
arranging 203 the absorption layer 52, 31 and the first security element 31 such that, in the case of observation of the first side of the security document 1, the first security element 2 is arranged behind the absorption layer 52, 31 and the first security element 2 is arranged in a first region 20, wherein the first region 20 overlaps the absorption region 30 partially or over the whole surface and the first region 20 does not overlap the absorption region 30 in a background region 21 directly adjacent to the absorption region 30, such that the at least one item of personalized information 3 has a viewing-angle-dependent contrast in a second region 22, which is formed at least by a partial region of the absorption region 30 and a partial region of the background region 21 directly adjoining it.

It is also possible for the arranging to be carried out in that, preferably after a lamination and/or a gluing of the layers of the security document 1, a blackening is introduced in the absorption region 30 by means of lasers, and/or to be carried out in that a first partial element 11, in particular of the system 10 according to the invention, which has the first security element 2, has been or is provided with a printed layer as absorption layer 52, such as for example the printed layer 31 described in relation to FIG. 2a, and is preferably then joined to further layers of the security document 1, in particular the second partial element 12, by gluing.

It is also possible for the following step to be carried out in particular before or after the arranging of the absorption layer 52 and the first security element 31:
introducing the at least one item of personalized information 3.

The introduction of the at least one item of personalized information 3 is preferably is carried out by means of a laser, in particular by blackening the absorption layer 52, and/or by printing the absorption layer 31.

It is also possible for example for the security document 1 to have been or to be joined by means of laminating to form a firm layer composite, as is shown schematically in cross section in particular by the figures.

A laminating for producing the security document 1 or in particular for joining the absorption layer 52 to a core layer 55 of the security element 2 preferably has been or is carried out by means of a pressure of from 10 N/cm² to 400 N/cm², preferably 40 N/cm² to 200 N/cm² is exerted on at least one or more layers selected from absorption layer 52, first security element 2, second security element 4, core layer 55, cover layer, in particular first cover layer 51 and/or second cover layer 56. It is possible for the laminating to be or to have been carried out by means of a temperature of more than 150° C., preferably between 160° C. and 210° C., which, from a heat source, in particular from one or more of the heated rollers or one or more of the heated plates, acts on at least one or more layers selected from absorption layer 52, first security element 2, second security element 44, core layer 55, cover layer, in particular first cover layer 51 and/or second cover layer 56. The laminating preferably is or has been carried out by means of a contact time of the heat source with at least one or more layers selected from absorption layer 52, first security element 2, second security element 4, core layer 55, cover layer, in particular first cover layer 51 and/or second cover layer 56, in a range of from 1 minute or more and 30 minutes or less. In the process, the contact of the heat source with one or more of the above-named layers is preferably effected directly or indirectly via further layers. The above settings are preferably to be used for a core layer 55, an absorption layer 52 and at least one cover layer, in particular first cover layer 51 and/or second cover layer 52, consisting of or comprising polycarbonate. For other materials, such as for example polyvinyl chloride, settings with respect to temperature and pressure differing from this and matched to the materials to be processed can be used. The application of KINEGRAM®TKO and KINEGRAM®GUARD to a substrate is also called laminating. Here, the TKO or GUARD product is applied to the surface, preferably by placing the film on the substrate, and the adhesive is activated via heated rollers. In the case of a TKO, transfer plies are preferably transferred and the polyester carrier is peeled off. In the case of the GUARD, a pre-punched film is in particular transferred with a polyester carrier, wherein the polyester carrier serves to protect against abrasion.

For producing the security document 1 it is possible in particular for the arranging to be carried out in that, preferably after a lamination and/or a gluing of the layers of the security document 1, a blackening is introduced by means of lasers in the absorption region 30, and/or to be carried out in that a first partial element 11, in particular of the system according to the invention, which has the first security element 2, has been or is provided with a printed layer 31 as absorption layer and is preferably then joined to further layers of the security element 2, in particular the second partial element 12, by gluing, in particular by bending the system 10. Thereafter, in particular the auxiliary carrier 105 can be detached from the carriers 103 and 104, with the result that a finished, personalized security document 1 is preferably produced.

Of course, the listed embodiment variants can be combined with each other as desired and do not represent a limitation.

### LIST OF REFERENCE NUMBERS

1 security document
10 system, label
11 first partial element
12 second partial element
103, 104 carrier layer
2 first security element
20 first region
21 background region
22 second region
3, 32 item of personalized information
30 absorption region
31 printed layer
4 second security element
41 third security element
42 fourth security element
51, 53, 54, 56 transparent layer
52, 521 absorption layer
55 core layer
550 window region
6 overlay/transparent second security element
7 substrate
8 printed layer
101 PSA (pressure sensitive adhesive)
102 covering
103, 104 carrier element
105 auxiliary carrier
201 carrier
202 detachment layer
203 replication layer
204 reflective layer
205 stabilizing layer
206 adhesive layer
300 patches
α inclination of the facets
β angle of reflection
Φ angle of incidence
h height
d length

1. Security document (1) comprising
a first side and a second side lying opposite the first side,
at least one absorption layer (52, 31) with an absorption region (30) for the formation of at least one item of personalized information (3), wherein the security document (1) has been processed and/or can be processed in the absorption region (30) such that the at least one item of personalized information (3) is visible, in particular visible to the human eye, through absorption of light incident on the first side;
a first security element (2) with an optically variable effect, wherein, in the case of observation of the first side, the first security element (2) is arranged behind the absorption layer (52, 31) and the first security element (2) is arranged in a first region (20), wherein the first region (20) overlaps the absorption region (30) partially or over the whole surface and the first region (20) does not overlap the absorption region (30) in a background region (21) directly adjacent to the absorption region (30), such that the at least one item of personalized information (3) has a viewing-angle-dependent contrast, in particular brightness contrast, in a second region (22), which is formed at least by a partial region of the absorption region (30) and a partial region of the background region (21) directly adjoining it.

2. Security document (1) according to claim 1,
characterized in that
the optically variable effect of the first security element (2) is visible, in particular is visible to the human eye, at a predefined first observation angle, and is not visible, in particular is not visible to the human eye, at a second predefined observation angle, wherein the first security element (2) is transparent at the second observation angle.

3. Security document (1) according to claim 1 or 2,
characterized in that
a difference in brightness between background region (21) and absorption region (30) in the second region (22) is stronger at a predefined first observation angle than at a predefined second observation angle.

4. Security document according to one of the preceding claims,
characterized in that
the arithmetic mean of measured values of the reflection and/or of the reflected and/or scattered light, preferably of grayscale values, in the first region is at least 5%, preferably at least 10%, further preferably at least 15%, greater at a predefined first observation angle than at a predefined second observation angle.

5. Security document according to one of the preceding claims,
characterized in that
the first security element is designed such that an increase in a brightness, in particular in the second region (22), is smaller in the absorption region (30) than in the background region (21) in the case of a change from observation at the predefined second observation angle to observation at the predefined first observation angle.

6. Security document according to one of the preceding claims,
characterized in that
the absorption region (30), at least in the first region, has an optical density with a maximum K value of 3, in particular measured according to ISO 13655:2017 (E).

7. Security document according to one of the preceding claims,
characterized in that
the contrast between absorption region (30) and background region (21) in the second region (21) has at most a value of 0.1, preferably 0.15, at the first observation angle.

8. Security document according to one of the preceding claims,
characterized in that
the optically variable effect of the first security element (2) is visible only when the first side is observed.

9. Security document according to one of the preceding claims,
characterized in that
the security document (1), preferably when observed from the first side behind the first security element, has a semi-transparent or opaque contrast layer to increase the contrast of the item of personalized information, in particular at an observation angle that is not the same as the first predefined observation angle, wherein the contrast layer preferably contains fillers, in particular contains TiO₂, for the preferably diffuse scattering of incident light.

10. Security document according to one of the preceding claims,
characterized in that
the security document (1) is semi-transparent or transparent, in particular not opaque, between the absorption layer and the first security element.

11. Security document according to one of the preceding claims,
characterized in that,
in a third region (40), the security document comprises a second security element (4) with an optically variable effect, which is arranged in front of the absorption layer (31, 52) when the first side is observed, in particular wherein the third region (40) does not overlap the absorption region (30) or overlaps it partially or over the whole surface.

12. Security document according to one of the preceding claims,
characterized in that
the first security element (2) and the second security element (4) are visible, in particular are visible with the human eye, when the first side is observed.

13. Security document according to one of the preceding claims,
characterized in that
the first security element (2) and the second security element (4) and in particular also the absorption region (30), preferably a blackening or printed layer of the absorption layer, overlap in an overlap region.

14. Security document according to one of the preceding claims,
characterized in that,
in the second region, in particular in the background region (21), the first security element (2) appears achromatic when observed at the predefined first observation angle.

15. Security document according to one of the preceding claims,
characterized in that,
at least in a first partial region of the absorption region (30), which forms a grayscale image or a multicolored image, preferably a portrait, the first security element (2) appears achromatic, in particular is achromatically visible, when observed at the predefined first observation angle.

16. Security document according to one of the preceding claims,
characterized in that
the first security element (2) forms only a partial region of the first side of the security document (1).

17. Security document according to one of the preceding claims,
characterized in that
the first security element (2) is arranged partially overlapping or overlapping part of the surface of at least one first partial region of the absorption region (30), which forms a grayscale image or a multicolored image, in a closed and coherent region with a minimum width or minimum length of 80%, preferably 100%, of a region (30) provided for the first partial region of the absorption region (30), wherein the provided region is preferably a region defined for a portrait.

18. Security document according to one of the preceding claims,
characterized in that
the first security element (2) is colored in a fourth region, wherein the fourth region overlaps, in particular in regions, a second partial region of the absorption region (30), which is preferably formed of alphanumeric characters.

19. Security document according to one of the preceding claims,
characterized in that
the at least one item of personalized information (3) is formed by means of manipulation of the absorption layer (52) with a laser, in particular through a blackening, and/or through a printed layer (31) comprised or formed by the absorption layer.

20. Security document according to one of the preceding claims,
characterized in that,
when the first side is observed, a further absorption layer (521) is arranged behind the first security element (2), in particular wherein the at least one item of personalized information (3) is composed of the absorption layer (52) and the further absorption layer (521) when observed at the second observation angle.

21. Security document according to one of the preceding claims,
characterized in that
the first security element (2) and/or the second security element (4) is designed semi-transparent and/or transparent.

22. Security document according to one of the preceding claims,
characterized in that
the second security element (4) is designed opaque, in particular has a transmittance selected from the range of from 0.1% to 30%, preferably from 1% to 10%, in the wavelength range visible to the human eye.

23. Security document according to one of the preceding claims,
characterized in that
the absorption region (30) is arranged in register with the background region (21).

24. Security document according to one of the preceding claims,
characterized in that
the first security element (2) and/or the second security element (4) has a carrier, in particular made of PET or PEN, wherein the carrier preferably has a layer thickness in a range of from 5 μm to 150 μm, further preferably from 5 μm to 50 μm, still further preferably from 10 μm to 25 μm.

25. Security document according to one of the preceding claims, characterized in that
the first security element (2) and/or the second security element (4) has at least one replication layer, in particular wherein the at least one replication layer has a layer thickness in a range of from 0.2 μm to 20 μm, preferably from 0.2 μm to 10 μm.

26. Security document according to one of the preceding claims,
characterized in that
the first security element (2) and/or the second security element (4) has at least one reflective layer with a preferred layer thickness selected from the range of from 40 nm to 200 nm, further preferably from 40 nm to 100 nm, wherein the reflective layer is formed in particular of ZnS or TiO₂ and/or wherein the reflective layer preferably has a refractive index of more than 1.9 in the wavelength range visible to the human eye, preferably of from 420 nm to 780 nm.

27. Security document according to one of the preceding claims,
characterized in that
the reflective layer is arranged over part of the surface or over the whole surface in the security document (1), preferably in the first security element (2), in particular wherein the reflective layer has different layer thicknesses at least over part of the surface.

28. Security document according to one of the preceding claims,
characterized in that
the first security element (2) and/or the second security element (4) has at least one stabilizing layer with a preferred layer thickness selected from the range of from 0.5 μm to 20 μm, further preferably from 1.0 μm to 10 μm, wherein the stabilizing layer is single-layered or multi-layered and preferably comprises an adhesion-promoter layer.

29. Security document according to one of the preceding claims, characterized in that
the first security element (2) and/or the second security element (4) has at least one adhesive layer with a preferred layer thickness selected from the range of from 0.2 μm to 20 μm, further preferably of 0.2 μm to 10 μm, in particular wherein the adhesive layer is formed of hot-melt adhesive or cold glue, and wherein the adhesive layer is designed single-layered or multi-layered.

30. Security document according to one of the preceding claims,
characterized in that
the first security element (2) and/or the second security element (4), in particular in the reflective layer and/or the replication layer, has at least one relief structure, in particular wherein the at least one relief structure deflects, preferably diffracts and/or reflects, the incident light in predetermined angle ranges.

31. Security document according to one of the preceding claims,
characterized in that
the at least one relief structure is a blazed structure, in particular with a grating period of more than 3 μm, further preferably more than 5 μm, and in particular at most 25 μm, and/or in a range of from 3 μm to 25 μm.

32. System (10) for producing a security document (1) according to one of the preceding claims comprising an auxiliary carrier (105), wherein a first partial element (11) of the security document (1) and a second partial element (12) of the security document (1) is arranged on the auxiliary carrier (105),
wherein the first partial element (11) can be made to overlay the second partial element (12) by bending the auxiliary carrier (105),
wherein the first partial element (11) optionally has a first carrier element (104) and has the first security element (2) and the second partial element (12) optionally has the second carrier element (103) and has an adhesive layer (101) and at least one covering and/or the second security element (4), wherein the adhesive layer (101) is arranged on the side of the covering and/or of the second security element (4) facing away from the auxiliary carrier (105), wherein the absorption layer (52, 31) with the absorption region (30) is arranged on or can be attached to the side of the first partial element (11) facing away from the auxiliary carrier (105).

33. System according to one of the preceding claims,
characterized in that,
in particular in the case of observation perpendicular to a plane spanned by the second partial element (12), the second security element (2) is present in more than 80% of the surface, preferably more than 90% of the surface, or over the whole surface in the second partial element (12) and comprises a reflective layer in the form of an HRI layer, in particular wherein a relief structure with a diffractive optical effect is molded in the reflective layer.

34. System according to one of the preceding claims,
characterized in that
a fold edge is arranged between the first partial element (11) of the security document and the second partial element (12) of the security document, wherein the fold edge separates the first partial element of the security document and the second partial element of the security document in such a way that the partial elements (11, 12) can be made to overlay by folding at the fold edge.

35. System according to one of the preceding claims,
characterized in that
the fold edge is present in a region in which neither the first carrier element (104) nor the second carrier element (103) is provided or in that first and second carrier element are formed by a layer which separates the first and second partial elements by a weak point, in particular an indentation, a scoring or a perforation, which form the fold edge, connects.

36. System according to one of the preceding claims,
characterized in that
the first security element (2) is arranged in the first partial element (11) of the security document on the side of the first carrier element (104) facing away from the auxiliary carrier (105) and in that the second security element (4) is arranged, preferably over part of the surface or over the whole surface, in the second partial element (12) of the security document between carrier element (103) and adhesive layer (101).

37. System according to one of the preceding claims,
characterized in that,
in the first partial element (11) and/or in the second partial element (12), at least one carrier layer, which in particular forms the first and/or second carrier element (103, 104), is arranged on a side facing the auxiliary carrier (105), wherein the carrier layer (103, 104) in particular consists of or comprises PET.

38. System according to one of the preceding claims,
characterized in that
the second partial element (12) of the security document has a protective layer (102), wherein the protective layer is arranged on the side of the adhesive layer (101) facing away from the second carrier element (103), wherein the protective layer is detachable from the adhesive layer and wherein the protective layer in particular consists of or comprises silicone.

39. Method for producing a security document (1), in particular a security document (1) according to one of the preceding claims, preferably using a system (10) according to one of the preceding claims, wherein the security document (1) comprises a first side and a second side lying opposite the first side, wherein the following steps are carried out:
providing at least one absorption layer (52, 31) with an absorption region (30) for the formation of at least one item of personalized information (3), wherein the security document (1) has been or is processed and/or can be processed in the absorption region (30) such that the at least one item of personalized information (3) is visible, in particular visible to the human eye, through absorption of light incident on the first side;
providing a first security element (2) with an optically variable effect;
arranging the absorption layer (52, 31) and the first security element (31) such that, in the case of observation of the first side of the security document (1), the first security element (2) is arranged behind the absorption layer (52, 31) and the first security element (2) is arranged in a first region (20), wherein the first region (20) overlaps the absorption region (30) partially or over the whole surface and the first region (20) does not overlap the absorption region (30) in a background region (21) directly adjacent to the absorption region (30), such that the at least one item of personalized information (3) has a viewing-angle-dependent contrast, in particular brightness contrast, in a second region (22), which is formed at least by a partial region of the absorption region (30) and a partial region of the background region (21) directly adjoining it.

40. Method for producing a security document according to one of the preceding claims,
characterized in that
the following step is carried out in particular before, during or after the arranging of the absorption layer (52, 31) and the first security element (31):
introducing the at least one item of personalized information (3).

41. Method for producing a security document according to one of the preceding claims,
characterized in that
the introduction of the at least one item of personalized information (3) is carried out by means of a laser by blackening the absorption layer (52) and/or by printing the absorption layer (31).
